(19) United States
(12) Patent Application Publication
(10) Pub. No.: US 2025/0370611 A1
(43) Pub. Date: Dec. 4, 2025

(54) ARTIFICIAL INTELLIGENCE TUNER FOR AUTOMATED VISUAL CONFIGURATIONS

(71) Applicant: FIGMA, INC., San Francisco, CA (US)

(72) Inventors: Alice CHING, Burlingame, CA (US); Kee Yen YEO, New York, NY (US); Kyung-Chui OH, Port Washington, NY (US)

(21) Appl. No.: 19/222,853

(22) Filed: May 29, 2025

Related U.S. Application Data
(60) Provisional application No. 63/652,821, filed on May 29, 2024.
(60) Provisional application No. 63/698,363, filed on Sep. 24, 2024.

(51) Int. Cl. G06F 3/04847; G06F 3/0482; G06F 3/04845; G06F 40/289; G06F 40/40; G06T 11/60

(52) U.S. Cl. CPC G06F 3/04847; G06F 3/0482; G06F 3/04845; G06T 11/60; G06F 40/289; G06F 40/40

(57) ABSTRACT

A computing device provides a design interface to enable a plurality of remote collaborators to design a presentation comprising a slide deck including multiple slides. The design interface enables the collaborators to implement style changes to the presentation, which may be propagated to the entire slide deck as well as to the design interface presentation on each computing device of each collaborator.

### CROSS REFERENCE TO RELATED APPLICATIONS

This application claims priority benefit of United States Provisional Patent Application titled “SYSTEM PROVIDING COLLABORATIVE DESIGN TOOLS”, filed on May 29, 2024, and having Ser. No. 63/652,821, and also claims priority benefit of United States provisional patent application titled, “ARTIFICIAL INTELLIGENCE TUNER FOR AUTOMATED VISUAL CONFIGURATIONS,” filed Sep. 24, 2024, and having Ser. No. 63/698,363. The subject matter of these related applications is hereby incorporated herein by reference.

### TECHNICAL FIELD

Examples described herein relate to user interface and presentation design tools for creating presentation content.

### BACKGROUND

Design tools have many forms and applications. For slide decks or presentations, a design interface may provide a set of design tools that enable a user to create visual and auditory experiences for an audience that may make the slide deck or presentation more compelling. As another example, design tools may enable designers to blend functional aspects of a program with aesthetics, resulting in a collection of pages that form a user interface of an application.

### BRIEF DESCRIPTION OF THE DRAWINGS

The disclosure herein is illustrated by way of example, and not by way of limitation, in the figures of the accompanying drawings in which like reference numerals refer to similar elements, and in which:

FIG. 1A is a block diagram illustrating a user computing device in communication with a network computer system, according to one or more examples.

FIG. 1B is a block diagram illustrating a network computer system implementing a collaborative design service, according to one or more examples.

FIG. 2A illustrates a menu of design templates for a workspace file, according to examples described herein;

FIG. 2B illustrates a slide deck buildout interface, according to examples described herein;

FIG. 3A illustrates a slide selection interface, according to examples described herein;

FIG. 3B illustrates a template properties panel for configuring a design template, according to examples described herein;

FIG. 4A illustrates automated configuration tools for a workspace file, in accordance with one or more examples;

FIG. 4B illustrates style editing and automated propagation across a workspace file, according to examples described herein;

FIGS. 4C and 4D illustrate an example theme swapping feature for propagating themes across a workspace file, according to example described herein;

FIG. 5 illustrates a grid view for a content design interface that facilitates design collaboration, according to examples described herein;

FIG. 6A illustrates a presenter notes feature and modality selector for a slide deck design interface, according to examples described herein;

FIG. 6B illustrates a modality change in the content design interface, according to examples provided herein;

FIG. 7A illustrates a presentation interactivity tool for creating two-way interactivity in a presentation, according to examples described herein;

FIG. 7B illustrates configuration of the presentation interactivity tool, according to certain examples described herein;

FIG. 8A illustrates an alignment scaling feature for receiving feedback in a workspace file, according to examples described herein;

FIG. 8B illustrates poll results from a collaboration team where feedback has been requested, according to various examples;

FIG. 9A illustrates a design editor providing slide notes for a presentation, according to certain examples;

FIG. 9B illustrates a presenter view for a presenter of a content file, according to examples provided herein;

FIG. 9C illustrates an example of an embedded prototype enabling audience interaction with a user interface design, according to examples described herein;

FIG. 10A illustrates an artificial intelligence (AI) dial enabling automated styling and/or tone configuration for a content design interface, according to one or more examples;

FIG. 10B illustrates a collaborative design interface in which collaborators have provided input for a content experience, according to examples herein;

FIG. 10C illustrates an AI-generated slide deck based on a collaborative design, according to certain examples;

FIG. 10D illustrates a presentation view for an audience of a designed presentation, according to certain examples herein;

FIG. 11A is a flow chart describing an example method of propagating text style changes across a presentation, according to various examples;

FIG. 11B is a flow chart describing an example method of modality changes on a collaborative design interface, according to certain examples;

FIG. 12 is a flow chart describing an example method of implementing alignment scaling for a collaborative design session, according to various examples provided herein;

FIG. 13 is a flow chart describing an example method of configuring an artificial intelligence (AI) model to generate automated content for a workspace file, according to various examples;

FIG. 14 is a flow chart describing an example of using an AI tool for automatically generating a slide deck from graphic content, according to various examples;

FIGS. 15A through 15C are example interfaces illustrating use of an example AI tuner, according to examples described herein;

FIGS. 16A and 16B are example interfaces illustrating the use of a custom preset on an example AI tuner on a selected user interface element, according to examples described herein;

FIGS. 17A through 17C are additional example interfaces illustrating the use of the custom preset on an example AI tuner, according to various examples;

FIGS. 18A and 18B are example digital posters in which a user utilizes an AI tuner, according to various examples;

FIG. 19 is a flow chart describing an example method of configuring and implementing an LLM prompt generator 85 dynamically based on user inputs on an AI tuner, according to examples described herein;

FIG. 20 is a block diagram illustrating a computer system on which one or more embodiments can be implemented; and

FIG. 21 is a block diagram illustrating a user computing device for use with one or more examples described herein.

### DETAILED DESCRIPTION

Examples described herein involve providing a collaborative content design service in which users may collaborate with other remote users to design content files for use in content presentations, such as slide deck presentations or other visual group presentations. In various examples, a user can execute a browser application on a computing device to interact with a current workspace file. Each workspace file can be stored in a backend computing system, and can comprise shared content for a particular content presentation. As provided herein, each workspace file can include a set of slides or user interface (UI) pages that any user or collaborators can edit to configure a presentation or user experience. As provided herein, “shared content” may be used interchangeably, and can refer to any content generated by an active workspace file that is configurable and editable by the user and/or a set of remote user collaborators. According to embodiments described herein, the user and one or more remote users can each provide input to edit and configure a workspace file.

A computing device can execute a browser application for enabling a user to configure and provide edits to a workspace file comprising any number slides or pages (e.g., slides of a presentation). In response to the selection input, the browser application can load the workspace file to the computing device of the user for presentation on a display or collaborative canvas. In certain examples, multiple remote collaborators can interact with and provide edits to a workspace file simultaneously. Changes made by each collaborator can be propagated to workspace files loaded on other collaborators by a backend computer system implementing the collaborative design service.

In certain aspects, each time a respective remote collaborator makes edits to a particular workspace file, change data is transmitted from the computing device of the remote collaborator to the backend computer system to automatically update active workspace data of the workspace file and propagate the edits to the computing devices of the other collaborators such that when these collaborators view the edited content, the edits have been incorporated. Accordingly, edits made by each of the plurality of remote collaborators to any content item of the workspace file are propagated to active workspace data corresponding to the workspace file at the backend network computer system.

As provided herein, a workspace file can correspond to a presentation, such as a slide deck, pitch deck, or any other presentation comprising multiple slides or pages with content for the presentation. In variations, the workspace file can correspond to a UI design for an application or website, in which the UI design can comprise multiple UI pages that are configured and designed by one or more user collaborators. In various implementations, the collaborative content design service may be facilitated by a backend computing system that stores workspace files for any number of user groups and/or collaborators. The backend computing system can provide each group with an account that enables access to a set of design tools for creating presentations or other content.

As provided herein, the set of design tools enable remote collaborators to structure the slides of a presentation, assign tasks or sections of the presentation to individual collaborators or groups, interact with intuitive editing tools for non-designers, interact with a full suite of design tools for professional designers and/or artists, provide audience interactivity, engage with other collaborators regarding directional alignment, interact with AI design aids for automating text and/or content for the presentation, adjust parameters of the AI design aids for generating automated text and/or content for the presentation, and the like. As such, improved collaboration is provided for remote design teams for creating and interacting with workspace files for a given presentation.

For example, the set of design tools can include an AI tuner comprising an interactive tone dial that enables a user to adjust various visual parameters of a single UI page, UI element, multiple UI pages or elements, a slide, a slide element, multiple slides or slide elements, or an entire slide presentation or UI design. In such examples, a user may interact with a UI design-under-edit or slide deck presentation, select one or more elements, and interact with the AI tuner to automatically configure a set of visual parameters of the selected elements. On the backend, the network computer system can include a large-language model (LLM) prompt generator that detects inputs by the user on the AI tuner (e.g., locations of an AI dial on a two-by-two grid having multiple AI parameters configured). The LLM prompt generator may then automatically generate an LLM prompt based on the inputs, transmit the LLM prompt to a third-party computing system executing an LLM, retrieve a dataset generated by the LLM that corresponds to the LLM prompt, and then implement the dataset on the selected elements presented on the computing device of the user. Further description of the AI tuner for visual elements is provided below.

As provided herein, a large-language model (LLM) can comprise a computational model capable of natural language processing tasks and can be trained using self-supervised or semi-supervised training using vast amounts of data. The LLM can comprise one or more artificial neural networks that can be fine-tuned for specific tasks via prompt engineering, which comprises the process of structuring an instruction that can be interpreted and understood by a generative AI model, such as a text-to-image model, text-to-text model, and/or a text-to-audio model. In examples provided herein, an automated LLM prompt generator is configured and executed to generate LLM prompts to fine-tune LLM outputs for the purposes of providing visual tuning for user interface, slide deck, or other designs under edit.

One or more embodiments described herein provide that methods, techniques, and actions performed by a computing device are performed programmatically, or as a computer-implemented method. Programmatically, as used herein, means through the use of code or computer-executable instructions. These instructions can be stored in one or more memory resources of the computing device. A programmatically performed step may or may not be automatic.

One or more embodiments described herein can be implemented using programmatic modules, engines, or components. A programmatic module, engine, or component can include a program, a subroutine, a portion of a program, or a software component or a hardware component capable of performing one or more stated tasks or functions. As used herein, a module or component can exist on a hardware component independently of other modules or components. Alternatively, a module or component can be a shared element or process of other modules, programs, or machines.

Some embodiments described herein can generally require the use of computing devices, including processing and memory resources. For example, one or more embodiments described herein may be implemented, in whole or in part, on computing devices such as servers, desktop computers, cellular or smartphones, tablets, wearable electronic devices, laptop computers, printers, digital picture frames, network equipment (e.g., routers) and tablet devices. Memory, processing, and network resources may all be used in connection with the establishment, use, or performance of any embodiment described herein (including with the performance of any method or with the implementation of any system).

Furthermore, one or more embodiments described herein may be implemented through the use of instructions that are executable by one or more processors. These instructions may be carried on a computer-readable medium. Machines shown or described with figures below provide examples of processing resources and computer-readable mediums on which instructions for implementing embodiments can be carried and/or executed. In particular, the numerous machines shown with embodiments include processor(s) and various forms of memory for holding data and instructions. Examples of computer-readable mediums include permanent memory storage devices, such as hard drives on personal computers or servers. Other examples of computer storage mediums include portable storage units, such as CD or DVD units, flash memory (such as carried on smartphones, multifunctional devices and/or tablets), and magnetic memory. Computers, terminals, network-enabled devices (e.g., mobile devices, such as cell phones) are all examples of machines and devices that utilize processors, memory, and instructions stored on computer-readable mediums. Additionally, embodiments may be implemented in the form of computer programs, or a computer-usable carrier medium capable of carrying such a program.

### System Description

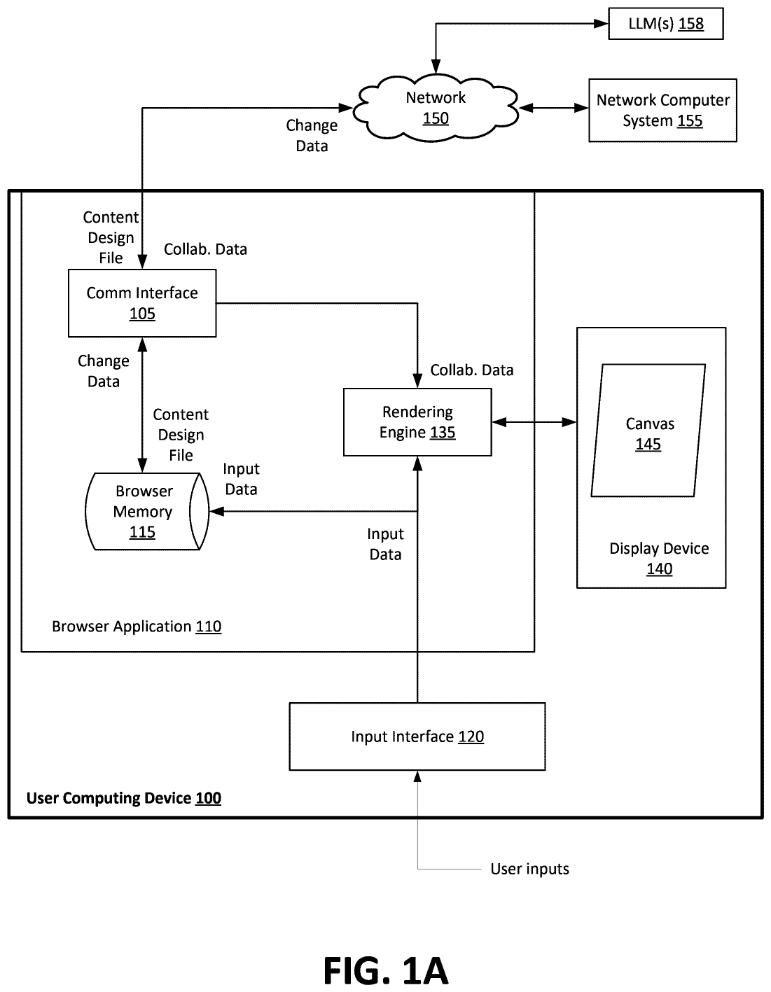

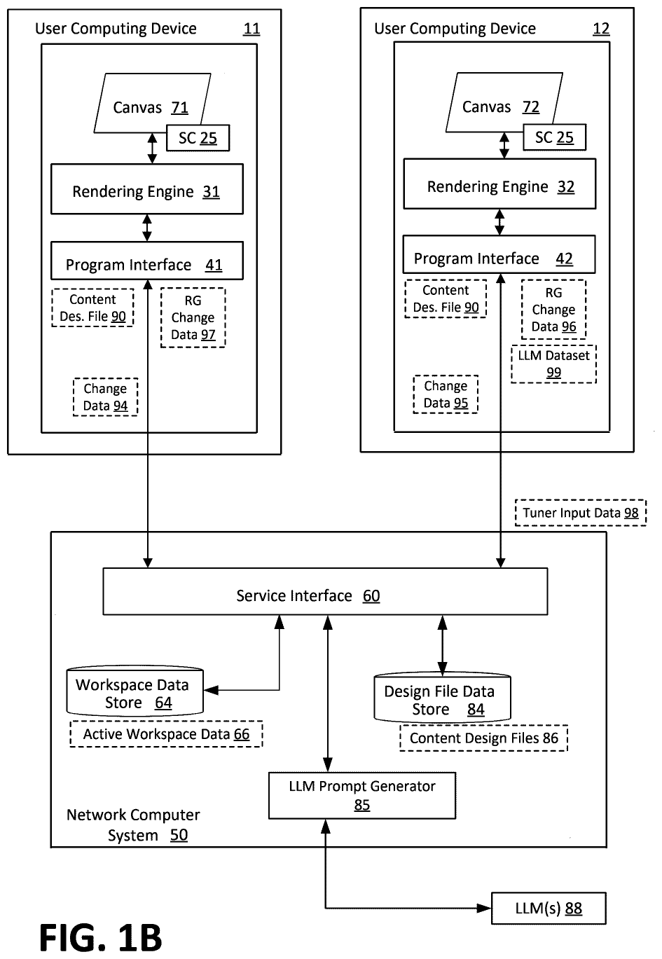

FIG. 1A is a block diagram illustrating a user computing device 100 in communication with a network computer system, according to one or more examples. In various implementations, the user computing device 100 can include a communication interface 105 that communicates with a network computer system 155 over a network 150 (e.g., Wi-Fi, cellular, satellite, etc.). As provided herein, the network computer system 155 can implement a collaborative platform that enables remote users to collaborate on a shared content. As further provided herein, a shared content can correspond to a slide deck, pitch deck, or presentation comprising respective sets of slides or pages. In some examples, the collaborative platform enables different types of application services to be used by collaborators. By way of example, the application service(s) can include (i) an interactive graphic application service, to enable users to create and share dynamic and interactive designs, including designs that can be prototyped or imported to a run-time environment, for example in accordance with a run-time simulation engine; (ii) a whiteboarding application service, to enable users to create and share visual content to share ideas with other users; and/or (iii) a presentation application service to enable users to create and share presentations (e.g., slides, slide deck, etc.).

In various examples, the user computing device 100 can comprise any personal computer, such as a tablet computer, desktop computer, laptop device, smartphone device, augmented reality (AR) or virtual reality (VR) headset device, and the like. The user computing device 100 can comprise an input interface 120, which can comprise a keyboard and mouse, a touch interface such as a track pad or touch-sensitive display, an interactive virtual display, and the like. The user computing device 100 can further include a display device 140, such as a computer screen or touch-sensitive display.

In various examples, the user computing device 100 can operate a browser application 110, which the user computing device 100 can initiate to provide access to the collaborative design service implemented by the network computer system 155. The browser application 110 can be executed to initiate a network connection with the network computer system 155 to enable a plurality of remote users to collaborate on one or more designs under edit corresponding to workspace files. For example, the user or a set of users may be associated with an account and/or profile with the network computer system 155 that includes a set of workspace files, which the user can edit and configure until finalized.

Based on the user inputs, a shared content—corresponding to the workspace file—can be presented, edited, and configured by the user on collaborative canvas 145 displayed on the display device 140. The user's edits on the workspace file can then be propagated to collaborative canvases presented on computing devices of any number of other users during a collaboration session. Along these lines, contributions from the other users to a shared content (e.g., a slide deck) can be propagated as collaboration data by the network computer system 155 to the shared content presented on the canvas 145 displayed on the display device 140.

Accordingly, the user and the remote users can engage with each other in real time during a collaboration session to provide input and edits to the shared content. For example, input data from the user can be processed by a rendering engine 135 of the browser application 110, which can generate content data to be displayed on the canvas 145 and transmitted over the network 150 to the network computer system 155 for propagation to the computing devices of other users in the collaboration session. As described, the browser application 110 also propagates the inputs provided by the other participants to the collaborative canvas 145 presented on the display device 140 of the user computing device 100. In certain examples, the browser application 110 can execute scripts, code, and/or other logic (the “programmatic components”) to implement the functionality of the rendering engine 135 described herein.

In certain examples, the browser application 110 can be implemented as web code that can include (but is not limited to) Hyper-Text Markup Language (HTML), JAVASCRIPT, Cascading Style Sheets (CSS), other scripts, and/or other embedded code which the browser application 110 receives from a network site. For example, the browser application 110 can execute web code that is embedded within a web page. The web code can also cause the browser application 110 to execute and/or retrieve other scripts and programmatic resources (e.g., libraries) from the network site and/or other local or remote locations. By way of example, the browser application 110 may include JAVASCRIPT embedded in an HTML resource (e.g., web page structured in accordance with HTML 5.0 or other versions, as provided under standards published by W3C or WHATWG consortiums) that is executed by the browser application 110. In some examples, the content rendering engine 135 of the browser application may utilize graphics processing unit (GPU) accelerated logic, such as provided through WebGL (Web Graphics Library) programs which execute Graphics Library Shader Language (GLSL) programs that execute on GPUs.

In some implementations, the rendering engine 135 can generate the collaborative canvas 145 using programmatic resources that are associated with the browser application 110 (e.g., an HTML 5.0 canvas). As an addition or variation, the rendering engine 135 can trigger or otherwise cause the collaborative canvas 145 to be generated using programmatic resources and data sets (e.g., canvas parameters) which are retrieved from local (e.g., memory) or remote sources (e.g., from network computer system 155). The browser application 110 may also retrieve programmatic resources that include an application framework for use with the collaborative canvas 145. The application framework can include data sets that define or configure a set of interactive graphic tools that integrate with the collaborative canvas 145. For example, the interactive graphic tools may enable the user to provide input for creating and/or editing a design interface.

Additionally, the rendering engine 135 can interpret an input action of the user based on the location of the detected input (e.g., whether the position of the input indicates selection of a tool, an object rendered on the collaborative canvas 145, or region of the canvas 145), the frequency of the detected input in a given time period (e.g., tap and hold), and/or the start and end position of an input or series of inputs (e.g., start and end positions of a drag input), as well as various other input types which the user can specify (e.g., pinch, zoom, scroll, etc.) through one or more input devices. In this manner, the rendering engine 135 can interpret, for example, a series of inputs as a design tool selection (e.g., shape selection based on location/s of input), as well as inputs to define properties (e.g., dimensions) of a selected shape.

In various examples, the rendering engine 135 operates to generate the user interface-which can include a shared content-presented on the display device 140. The user interface can include graphic elements and their respective properties to enable the user to edit the shared content using the input interface 120. As an addition or alternative, the rendering engine 135 can generate a blank page for the collaborative canvas 145, and the user can interact with various displayed tools to initiate a shared content (e.g., corresponding to a presentation or slide deck). As rendered, the shared content can include graphic elements such as a background and/or a set of objects (e.g., shapes, text, images, programmatic elements), as well as properties of the individual graphic elements. The shared content can be generated using, for example, an interactive graphic design application service, a whiteboarding application service, or a presentation application service.

Each property of a graphic element can include a property type and a property value. For an object, the types of properties include shape, dimension (or size), layer, type, color, line thickness, font color, font family, font size, font style, and/or other visual characteristics. Depending on implementation details, the properties reflect attributes of two or three-dimensional designs. In this way, property values of individual objects can define visual characteristics such as size, color, positioning, layering, and content for elements that are rendered as part of the shared content.

Individual design elements may also be defined in accordance with a desired run-time behavior. For example, some objects can be defined to have run-time behaviors that are either static or dynamic. The properties of dynamic objects may change in response to predefined run-time events generated by the underlying application that is to incorporate the shared content. Additionally, some objects may be associated with logic that defines the object as being a trigger for rendering or changing other objects, such as through implementation of a sequence or workflow. Still further, other objects may be associated with logic that provides the design elements to be conditional as to when they are rendered and/or their respective configuration or appearance when rendered. Still further, objects may also be defined to be interactive, where one or more properties of the object may change based on user input during the run-time of the application.

In various implementations, the browser application 110 enables a user to interact with the canvas 145 to create design elements, where design elements can have spatial and logical relationships to one another. Design elements can be linked, for example, as having parent/child relationship, or alternatively referred to as nested design elements. In examples, nested design elements can have a spatial and logical relationship with one another. For example, a design element can be nested within another design element, meaning a boundary or frame of the design element (e.g., child element) is contained within the boundary or frame of the other design element (e.g., parent element).

Further, nested design elements can be logically linked, such as in a manner where design input to either design element can trigger rules or other logic that affect the other design element. The rules or logic that affect nested design elements can serve to maintain the design elements in their spatial relationship, such that one node remains the parent of the other (or one node remains the child of the other) despite, for example, resize or reposition input that would otherwise affect the parent-child spatial relationship. Thus, for example, nested design elements can be subject to a common set of constraints, as well as other functional features (e.g., auto-layout). Still further, as another example, the design input to move one of the design elements of a nested pair can result in the other design element being moved or resized.

In variations, design elements of each slide in a slide deck of a presentation can include any combination of static or dynamic objects, such as images, videos, GIFs, active objects (e.g., active emojis or animations), static or active text, fade outs or wipes, audio cues, audio accompaniments, and the like. These design elements may be included in a design template for a slide deck, or may be created by a collaborator using design tools, which can include basic design tools that are configured to be intuitive for non-designers, or more complex design tools that enable professional designer to create customized or fine-grained objects and features.

For UI or presentation design examples, the browser application 110 enables users to specify flows that specify sequences (including alternative sequences) amongst multiple slides. For example, a user can specify logical connections amongst a collection of cards, where the logical connections specify a sequence. As individual cards may specify, for example, alternative states of same screen or interface, the use of such logical connectors can specify state changes or flows of the user interface or presentation when in production, where the state changes or flows are responsive to events (e.g., user input) which may occur in such production-environment. The browser application 110 can determine and utilize a common hierarchical logical data structure to represent a collection of cards.

For example, a hierarchical nodal representation can be maintained for the collection of cards, where the representation includes a top-level node and sub-nodes with additional hierarchically arranged nodes. Accordingly, in examples, each card of the collection can be represented by a root node (Level 0, or top-most level node), and each design element can be represented as a sub-node of the root node. Within each root node, sub-nodes can be arranged to have different levels. A top-most sub-node of the root node (i.e., Level 1 node) can include design elements of the card that are not children of any other design elements except for the top-level frame represented by the root node. In turn, any child design element to one of the design elements represented by a top-level sub-node (Level 1) can be represented by a second level sub-node (i.e., Level 2 node) and so forth. The design-mode nodal representation can be determined for each card, and further combined for all the cards of the collection. The design-mode nodal representation of the collection can be provided by the browser application 110 as, for example, part of a separate panel in a tool panel presented on the canvas 145.

Further, in examples, the active workspace data from which shared content is generated on individual user devices can include data describing the set of nodes along with data describing the hierarchical structure. Within the hierarchical structure, relationships between nodes may denote an arrangement of layers, where individual layers correspond to a frame object, a group of frame objects, or a specific type of frame object. In context of such examples, nodes in the layers can represent design elements within the design interface. Each node and/or layer can also be characterized by a set of attributes that reflect the visual appearance of the corresponding design element. The attributes of each node and/or layer can be selected or manipulated by users. By way of illustration, a user can modify individual nodes and/or layers by specifying (i) a numeric value to represent a line, corner or dimensional characteristic of a frame object; (ii) a color value (e.g., which can be formatted as HEX, HSB, HSL, CSS and RGB) for a background, or for a fill, line or shading attribute of an object; (iii) a shape or type characteristic; and/or (iv) a text string attribute (e.g., text carried by the content element).

In certain examples, the rendering engine 135 can process input data corresponding to user inputs provided on the display device 140, where the input data indicates (i) an input action type (e.g., shape selection, object selection, sizing input, color selection), (ii) an object or objects that are affected by the input action (e.g., an object being resized), (iii) a desired property that is to be altered by the input action, and/or (iv) a desired value for the property being altered. The rendering engine 135 can implement changes indicated by the input data to locally update active workspace data presented on the display device 140. The rendering engine 135 can update the collaborative canvas 145 to reflect the changes to the affected objects in the shared content.

In variations, the rendering engine 135 can process input data corresponding to user inputs provided via the input interface 120, which can correspond to keystrokes on a keyboard and mouse inputs (e.g., cursor movements and clicks), or can correspond to a combination of user inputs provided via the input interface 120 and user inputs provided on the display device 140. For presentation or slide deck implementations, the browser application 110 can download and render a workspace file from the network computer system 155 corresponding to a particular presentation. The browser application 110 can include a browser memory 115 that enables the user to make changes to the workspace file locally, which are then propagated as change data to the shared canvas 145 presented on the computing devices of other collaborators.

Likewise, collaboration data corresponding to inputs provided by the collaborators can be processed and propagated to the workspace file at the browser memory 115 by the network computer system 155, which may then update the shared content presented on the respective canvas 145. Accordingly, all design changes made by each remote collaborator are propagated to the other devices by the network computer system 155 via the browser application 110. On each user device, the browser application 110 updates the workspace file stored at the network computer system 155 as well as the workspace file loaded locally in the browser memory 115.

As described in detail below, the browser application 110 can provide the user and remote collaborators with tools for creating slide decks, presentations, and UI designs. These tools can provide interactivity between the collaborator during the design process, and can further provide interactivity with a subsequent audience of the presentation. Furthermore, one or more AI design aids can be implemented to automate certain graphic elements, themes, objects, or text for the presentation. As provided herein, the browser application 110 may operate in concert with the network computer system 155 and, in certain examples, one or more third-party AI service providers (e.g., one or more computing systems implementing one or more large-language models (LLMs) 158) to perform these automated functions. In some variations, the browser application 110 can generate multiple types of tools, such as a set of tools for a graphic design application service, a set of tools for a whiteboarding application service and/or a set of tools for a presentation (or slide) application service. As an example, the network computer system 155 can detect AI tuner inputs by a particular user or collaborator. The AI tuner inputs can correspond to a user configuring one or more AI visual parameters, presets, or AI dial inputs in which the user or collaborator moves the AI dial along multiple axes (as described in detail below). The network computer system 155 can include an automated LLM prompt generator that processes the inputs by the user or collaborator, automatically generates an LLM prompt based on the inputs, transmits the LLM prompt to a respective LLM 158, and receives a dataset generated by the LLM that corresponds to the LLM prompt.

As an addition or variation, the presentation application service can enable the user to toggle between different types of tools for the graphic design application service and/or the whiteboarding application service. By way of example, the whiteboarding set of tools can enable the user to select objects by shape, type (e.g., geometric object, and text-based object (e.g., stickie note). Further, the whiteboarding set of tools can include functional and interactive graphic elements, such as stamps (which mark text or graphic elements on a canvas) and widgets. Widgets include persistently renderable and interactive graphic elements that can be subject to design input (e.g., change color, size) and enable predetermined functionality (e.g., voting) for collaborating users. Further, the whiteboarding set of tools can enable the user to configure attributes for selected objects, where the attributes include, for example, color fill, size, line attributes and text properties. Alternatively, the user can switch to using a design set of tools with the presentation application service. The design set of tools can enable users to select frames, frame attributes, relationships between frames, and other attributes. The design tools can enable users to apply attributes to select frames, such as, for example, fill attribute (e.g., pattern, color, etc.), line attributes (e.g., line weight, color, pattern, end detail) and text attribute. Still further, the design tools can enable users to specify one or more types logical relationships (e.g., parenting, auto-layout, etc.) between frames, including spacing or logical relationship.

### Collaborative Network Platform

FIG. 1B illustrates a network computer system implementing a collaborative web service, according to one or more examples. In an example of FIG. 1B, a collaborative network platform is implemented by the network computer system 50, which communicates with multiple user computing devices 11-12 over one or more networks (e.g., the World Wide Web) to present a shared, collaborative design interface on the user computing devices 11-12. While FIG. 1B illustrates an example in which two users utilize the collaborative network platform, examples as described allow for the network computer system 50 to enable collaboration on design interfaces among users using a larger number of user computing devices. Among other advantages, the collaborative network platform allows users to more concurrently access a design interface, and to conveniently manipulate objects while the network computer system 50 manages synchronization and access issues.

With respect to FIG. 1B, the user computing devices 11-12 can be operated by users that are associated with a common account or accounts associated with a shared content 25 (e.g., shared content, whiteboarding content, etc.). Each user computing device 11-12 presents the shared content 25 (e.g., corresponding to a UI design, slide deck, and/or presentation) on a collaborative canvas 71-72 provided by each device during respective sessions. As such, each of the user computing devices 11-12 may access a workspace file 90 at the same time using respective program interfaces 41-42 on each of the user computing devices 11-12. As provided herein, the workspace file 90 accessed and downloaded by the browser applications on the user computing devices 11-12 can be provided by a design file data store 84 storing workspace files 86 for any number of users and user accounts at the network computer system 50.

In examples, the service interface 60 can load the workspace file 90 corresponding to the shared content 25 from design file data store 84, and upload the workspace file 90 to each user computing device 11-12 such that the respective rendering engines 31-32 render the shared content 25 corresponding to the workspace file 90 (e.g., during overlapping sessions). In certain examples, when a collaboration session is initiated, a workspace data store 64 of the network computer system 50 can initiate active workspace data 66 corresponding to the workspace file 90 to dynamically propagate changes made by each collaborator.

As such, the network computer system 50 can continuously synchronize the edits to the workspace file 90 corresponding to the shared content 25 presented on the user computing devices 11-12. Thus, changes made by users to the shared content 25 on one user computing device 11 may be reflected on the shared content 25 rendered on the other user computing device 12 in real-time. By way of example, when a change is made to the shared content 25 at one user computing device 11, the respective rendering engine 31 updates the respective canvas 71 locally and transmits change data 94 corresponding to the changes to the service interface 60 of the network computer system 50 (e.g., via content rendering engine 135).

The service interface 60 processes the change data 94 from the user computing device 11 and uses the change data 94 to make a corresponding change to the workspace file 90. The service interface 60 can also transmit remotely-generated change data 96 (which in the example provided, corresponds or reflects the change data 94 received from the user computing device 11) to the other user computing device 12 that has loaded the same shared content 25, causing the corresponding rendering engine 32 to generate the changes to the shared content 25 accordingly, such as by causing the program interface 42 and rendering engine 32 to update the respective collaborative canvas 72. In this manner, active workspace data 66 is synchronized across any number of user computing devices 11-12 that are using the respective workspace file 90.

Likewise, the service interface 60 processes the change data 95 from the user computing device 12 and uses the change data 95 to make a corresponding change to the workspace file 90. The service interface 60 can also transmit remotely-generated change data 97 (which in the example provided, corresponds or reflects the change data 95 received from the user computing device 12) to the other user computing device 11 that has loaded the same shared content 25, causing the corresponding rendering engine 31 to generate the changes to the shared content 25 accordingly, such as by causing the program interface 41 and rendering engine 31 to update the respective collaborative canvas 71. In this manner, active workspace data 66 corresponding to the workspace file 90 is synchronized across any number of user computing devices 11-12 that are using the respective workspace file 90.

In certain examples, to facilitate the synchronization of the edits and changes made at the user computing devices 11-12 and the network computer system 50, the network computer system 50 may implement a stream connector to merge data streams between the network computer system 50 and user computing devices 11-12 that have loaded the same shared content 25. For example, the stream connector may merge a first data stream between user computing device 11 and the network computer system 50 with a second data stream between user computing device 12 and the network computer system 50. In some implementations, the stream connector can be implemented to enable each computing device 11-12 to make changes to the server-side workspace file 90 at the design file data store 84 without added data replication that may otherwise be required to process the streams from each user computing device 11-12 separately.

In certain implementations, the shared content 25 or content design file 86 presented on the canvas 71, 72 of either device can include design tools that the users can utilize to update and change visual designs of a UI page, UI element or frame, slide, or slide deck elements. In various examples, the design tools can include an artificial intelligence (AI) tuner that is configurable to enable the user to utilize automated LLM prompting to change various visual aspects of the UI page, UI element or frame, slide, or slide deck element. Detailed description of the AI tuner, AI presets, and user interaction with the AI tuner is described below.

In various implementations, the network computer system 50 includes an LLM prompt generator 85 that processes user inputs on the AI tuner, For example, the LLM prompt generator 85 can receive tuner input data 98 corresponding to a user's interactions with the AI tuner. Based on the tuner input data 98, the LLM prompt generator 85 can translate the inputs to generate an LLM prompt, and transmit the LLM prompt to an external computing system that implements an LLM 88. As provided herein, the LLM prompt can comprise text content instructing the LLM to update the styling, font, color scheme, design, and other visual parameters of a selected UI element, page, slide, or slide element, and the like. The LLM prompt can further provide the LLM 88 with a set of mappings (e.g., JSON mappings) for the design-under-edit that are to be visually updated.

In further examples, the LLM prompt can describe a coordinate system with each axis representing particular AI parameters. For example, the negative y-axis can represent a “playful” parameter, the positive y-axis can represent a “professional” parameter (e.g., the opposite of “playful”), the negative x-axis can represent a “minimal” parameter, and the positive x-axis can represent a “vibrant” parameter (e.g., the opposite of “minimal”). In various examples, these parameters can be reconfigured by the user via a set of suggestions or using any parameters (e.g., typed in descriptive words) that are interpretable by the LLM. The LLM prompt can include the AI parameters, coordinate information corresponding to a location of an AI dial in the coordinate space (e.g., as placed by the user), and file information corresponding to the workspace file being designed by the user. Further information can also be included in the LLM prompt, such as definitions of each parameter (e.g., font information, color and styling information, sizing information, design scheme information, and the like).

In various examples, the LLM 88 can process the LLM prompt and generate a dataset 99 that, when processed by the network computer system 50 and/or rendering engine 32, causes the selected element(s) to be automatically updated. As described herein, the LLM prompt generator 85 can operate in real time (e.g., within a second of delay), such that real-time inputs on the AI tuner and AI dial can result in real-time updates to the selected elements presented on the canvas 72. Accordingly, as the user manipulates the AI tuner and AI dial, the LLM prompt generator 85 operates dynamically on the backend to generate prompts based on respective positions of the AI dial, and rapidly communicate with the LLM 88 to respond to the user's inputs with LLM generated datasets to update the various aspects of the selected elements. Further description of the AI tuner, AI dial, and AI parameters for automatically generating LLM prompts and dynamically updating the visual design, scheme, coloring, and other visual parameters of selected UI elements is provided below.

### Example User Interfaces

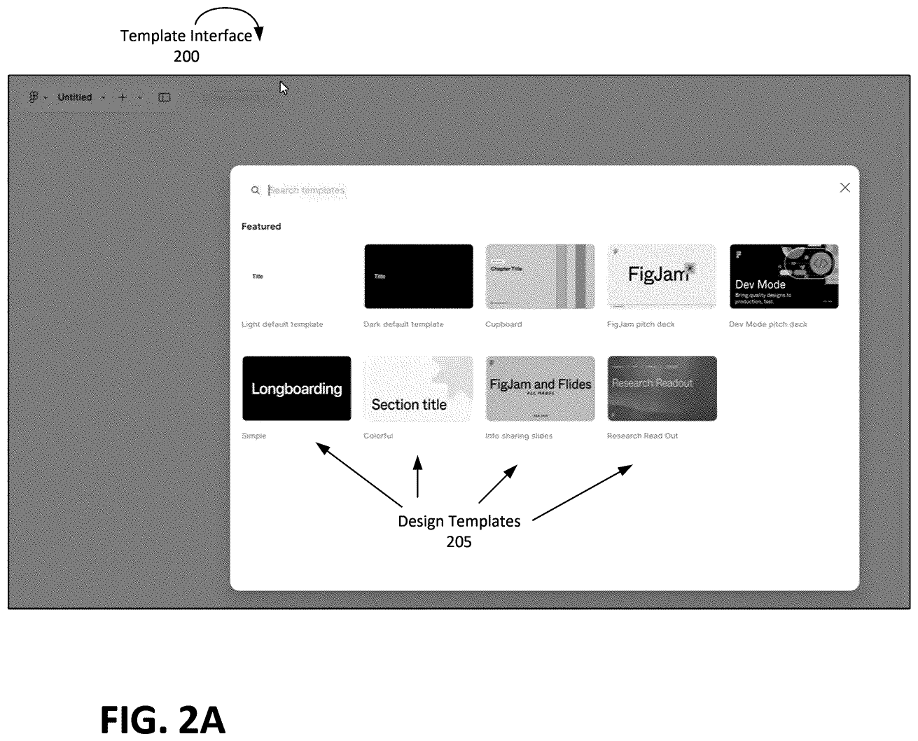

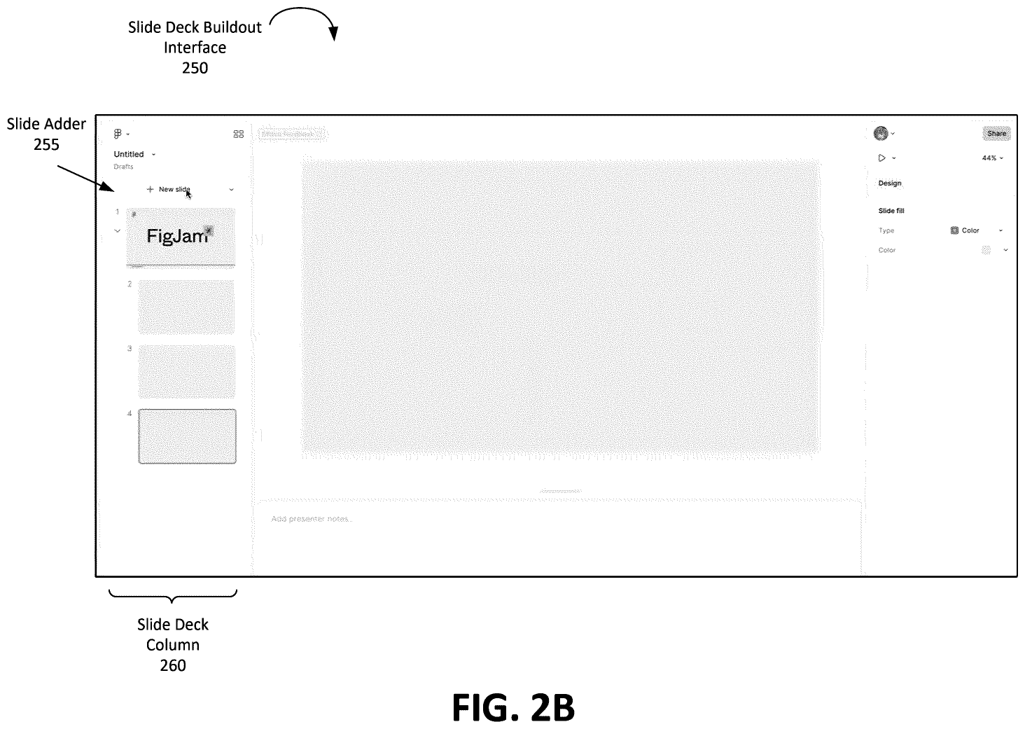

FIG. 2A through FIG. 10D illustrate various interfaces and functionality for implementing examples, as described with one or more embodiments. Examples can be provided through a browser application 80, an application service, or through an interactive system for providing an application or suite of application services. In examples, functionality as described can be implemented through a presentation application or presentation application service, such as may be implemented though the network system 155 and/or browser application 110.

FIG. 2A illustrates a menu of design templates 205 for a workspace file, according to examples described herein. In the example shown in FIG. 2A, a user can execute the browser application and interact with content features to create a presentation. As shown in FIG. 2A, a template interface 200 presented via the browser application can include a set of design templates, each of which can include a unique theme comprising stylistic features such as color(s), font style and size, design features, and the like. In certain examples, when the user selects a particular design template 205, all subsequent slides may incorporate the stylistic features of the selected template.

FIG. 2B illustrates a slide deck buildout interface, according to examples described herein. Upon selecting a design template 205, a slide deck buildout interface 250 can be presented that enables the user to add new slides to the slide deck. The user may select a slide adder 255 to add any number of slides, which may be automatically ordered in a slide deck column 260 of the buildout interface 250. As shown in FIG. 2B, each new slide can comprise certain stylistic elements of the design template 205 selected by the user (in this case, as thematic color).

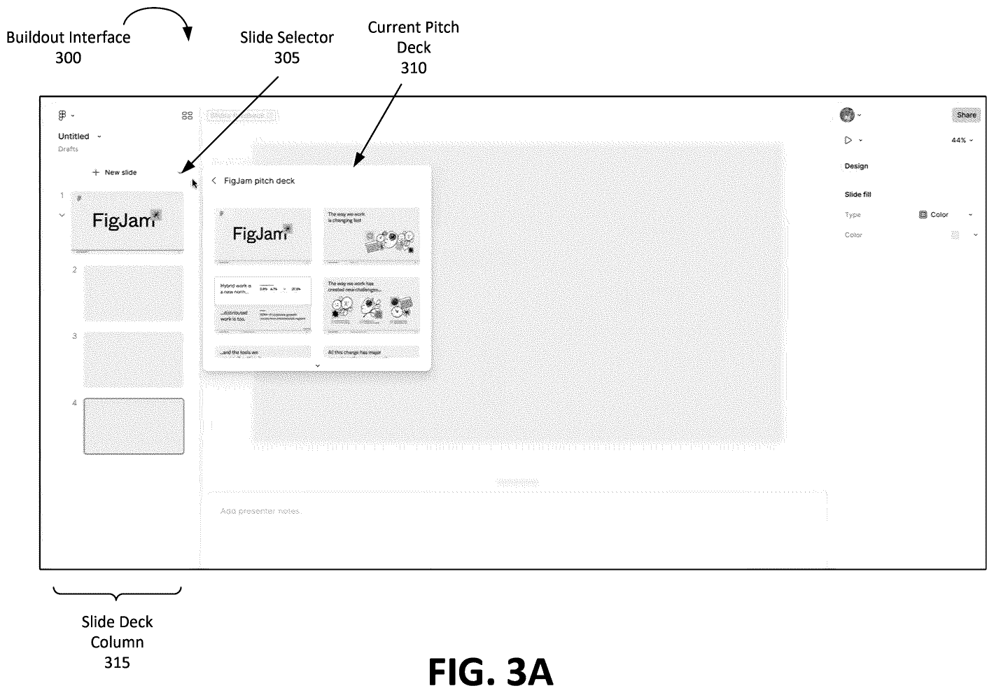

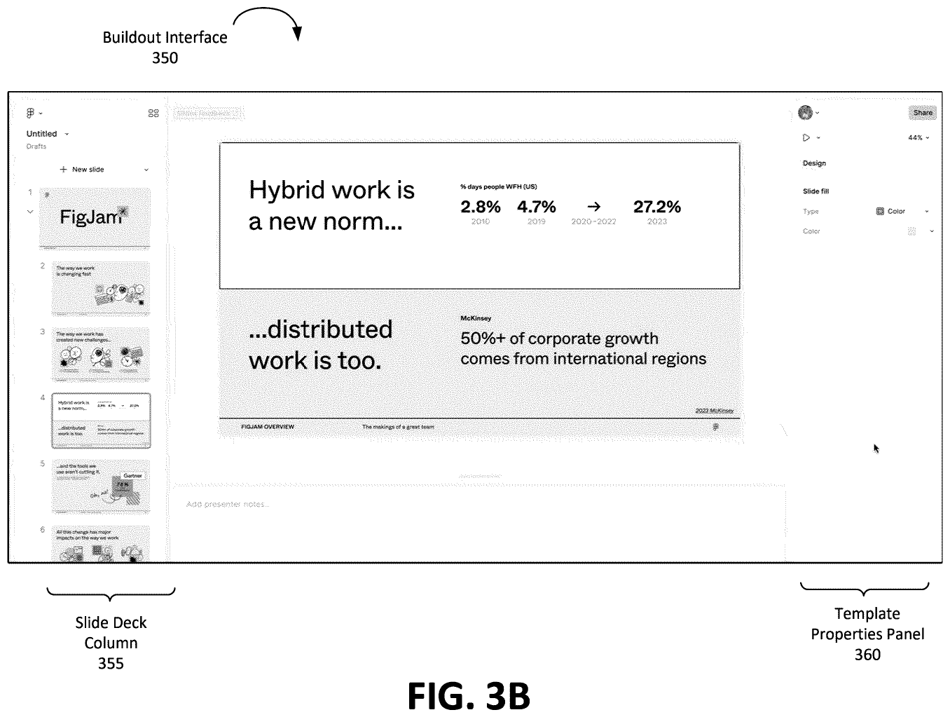

FIG. 3A illustrates the buildout interface 300 including a slide selector 305, according to certain examples. The slide selector 305 may be selected by the user to present a current pitch deck 310 that includes previously configured slides (e.g., from a different workspace file of the same account). The user may select from any of the slides of the current pitch deck 310 to include into the slide deck column 315 of the new presentation.

FIG. 3B illustrates the buildout interface 350 including a template properties panel 350 for configuring a design template or a new presentation, according to examples described herein. As shown in FIG. 3B, the user may incorporate any number of slides from a current slide deck into the slide deck column 355. A template properties panel 350 is included to enable the user to make global changes to the selected design template 205 and/or the slides of the slide deck column 355.

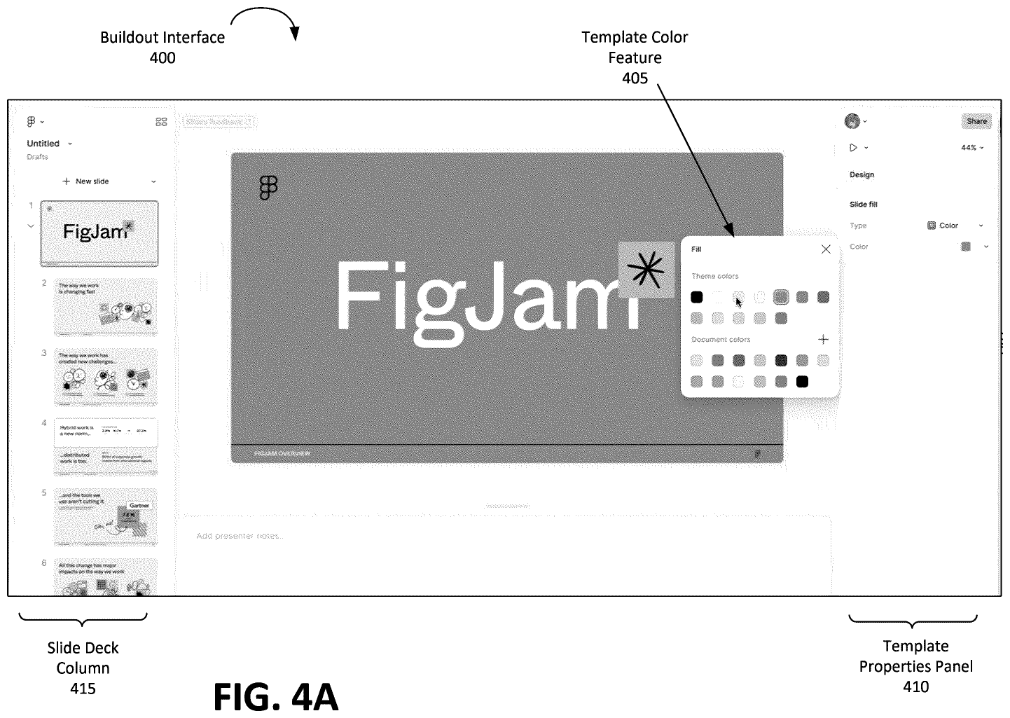

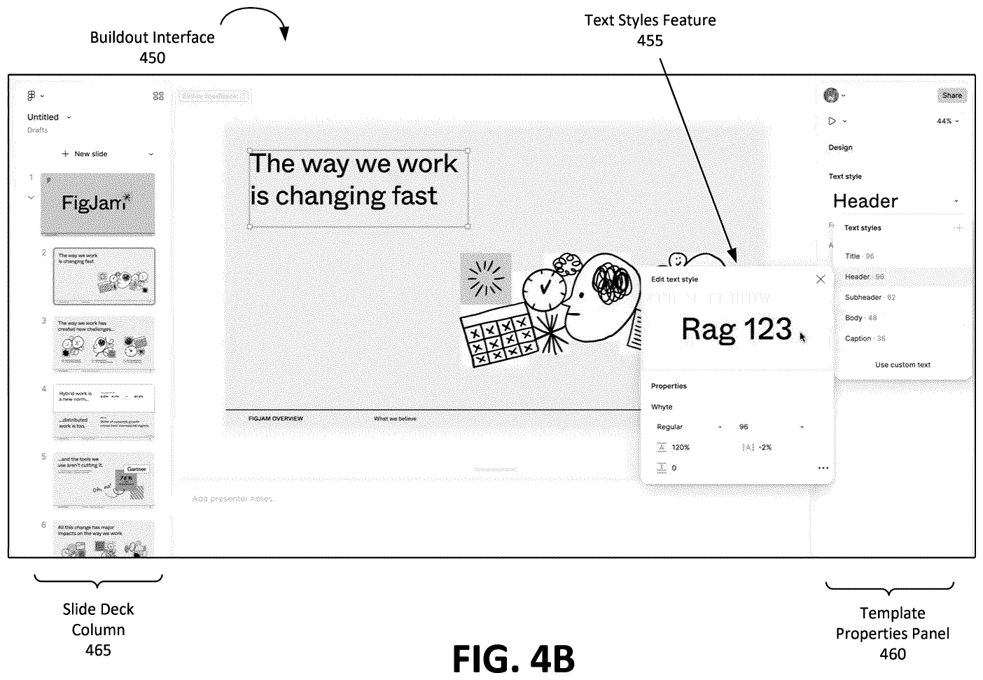

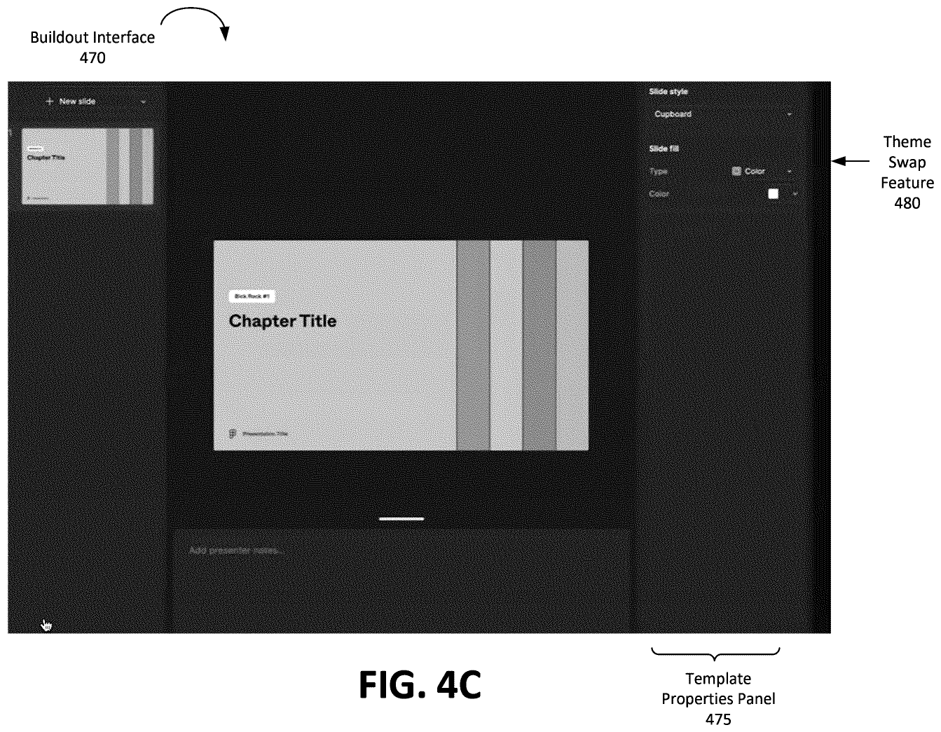

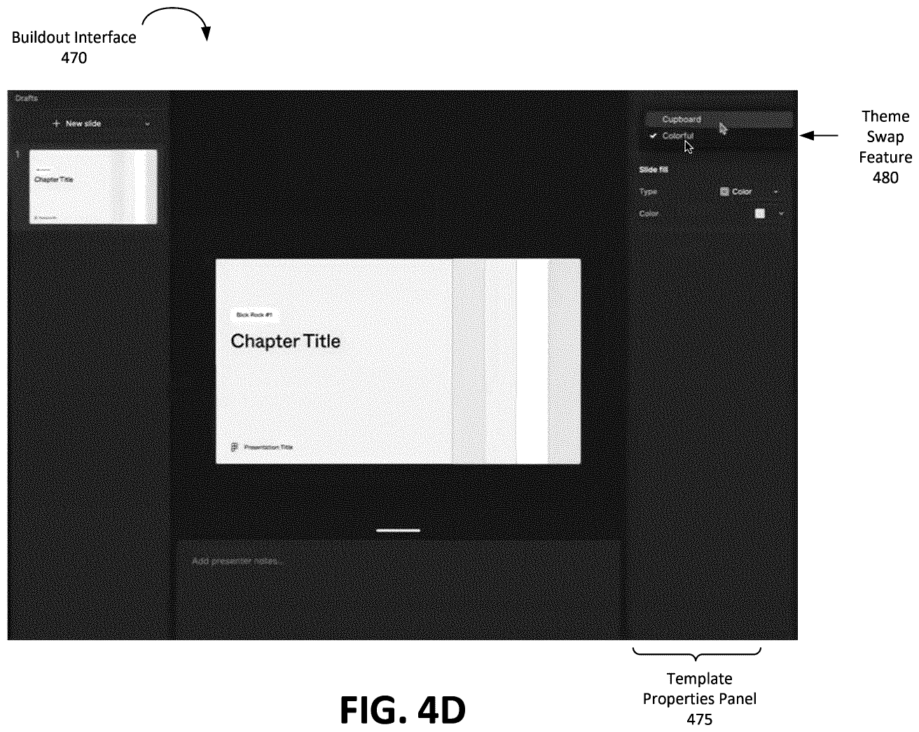

FIG. 4A illustrates automated configuration tools for a workspace file, in accordance with one or more examples. As shown in FIG. 4A, the user can interact with various features of the template properties panel 410 to enable the user to make stylistic changes to the slide deck or the design template itself, such as thematic changes involving color combinations, text size and color, and the like. As further shown in FIG. 4A, the user may interact with a template color feature 405 to change the theme color or document color of the various slides in the slide deck column 415 or to the design template itself. When a color is selected, the browser application can automatically change the font, font weight, or text color based on one or more contrasting parameters. For example, dark colors selected by the user may result in light colored text and light colors selected by the user may result in dark colored text. Upon selecting a particular color for the design template, the browser application may propagate the color change (and automated text color change) across all slides of the slide deck and/or design template.

FIG. 4B illustrates style editing and automated propagation across a workspace file or design template, according to examples described herein. As shown in FIG. 4B, the buildout interface 450 can present the slide deck column 465 and template properties panel 460, which also enables the user to interact with a text styles feature 455 to make global changes to the text of the slide deck and/or design template. These global changes can comprise changes to font, text size, font weight, line height, character spacing, paragraph spacing, and/or text color of any of the title of each slide, the header for each slide, the sub-header of each slide, the body of each slide, or the caption of each slide. When the user makes a change to the text style of any of these categories on one slide using the text styles feature 455, the browser application may propagate the change to all of the slides where relevant. Accordingly, as shown in the example of FIG. 4B, a change to the text size of the header of the selected slide in the slide deck column 465 can be propagated to the headers of all other slides in the slide deck. In further examples, a user can also import text styles and color styles from a design library of the collaborative design service, which can be accessed by the user in the text styles feature 455 to make global changes to the slide deck.

FIGS. 4C and 4D illustrate an example theme swapping feature 480, according to various examples. As provided in FIG. 4C, a buildout interface 470 can include a template properties panel 475 that includes a theme swap feature 480. Upon selecting the theme swap feature 480, the user may be presented with a set of theme options (e.g., in a theme menu), as shown in FIG. 4D. Upon selecting a theme from the set of theme options, various features of the slide deck may be altered, such as font type, font weight, font size, color pattern, and other visual elements. As provided herein, the selected theme may also be propagated throughout the entire slide deck. The set of theme options in the menu may be accessed from other slide decks of the user or account or from a set of theme templates of the collaborative design service. In certain examples, the themes may be pre-populated in the menu from template themes, themes recently used by the user or the user's account, or themes preselected by the user.

In some examples, the content of the slide deck can include variable design. A design element (alternatively named “variants” or “components”) has a set of attributes which can vary. For example, a variant can have a color attribute (e.g., fill color, line color), line attribute, shape, size that is designated as a variable. When multiple variants are provided with a slide deck, a user can designate a theme by defining alternative values for each variant component of the slide deck. The values can be specified by, for example, a table that lists alternative values for each variant. The collection of specific values for all of the variants can define, at least in part, the theme of the slide deck. A variant table can store multiple predetermined values for the variant components of the slide deck. For example, the variant table can list the variant components vertically, and the alternative values for the variant component row-wise or horizontally. In this way, each column can collectively define a theme, with the value of each variant being specified for that theme or column.

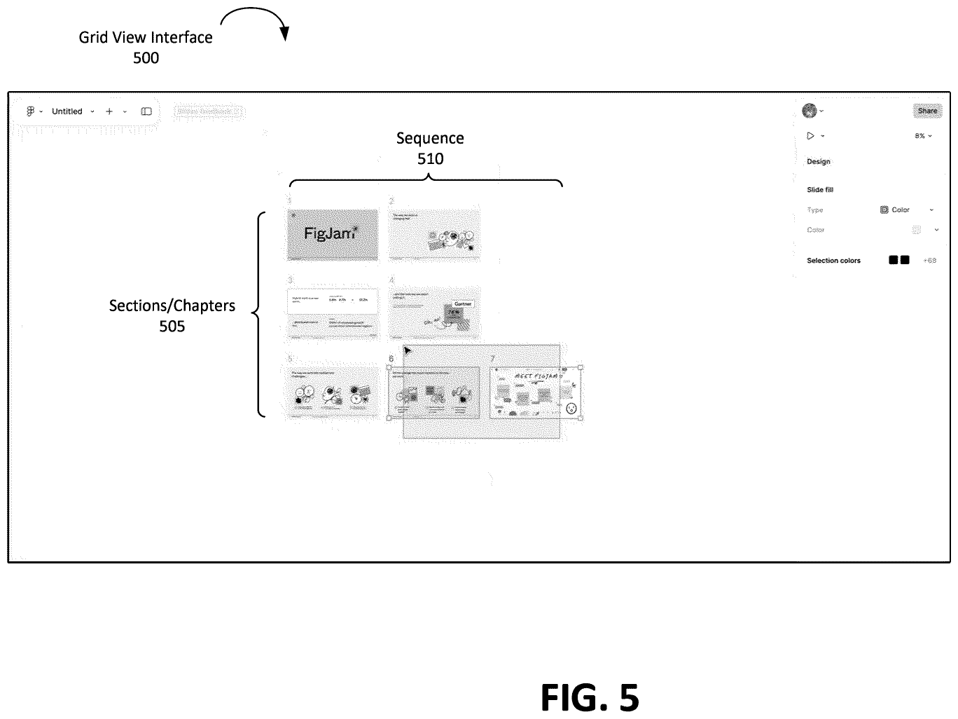

FIG. 5 illustrates a grid view interface 500 for a workspace file that facilitates design collaboration, according to examples described herein. Referring to FIG. 5, the user may select a grid view feature that causes the browser application to present the slide deck in the grid view interface 500, which arranges the slides in the presentation sequentially in a horizontal axis or a set of rows and by section or chapter in the vertical axis or a set of columns. Thereafter, as shown in FIG. 5, the user can structure the presentation by selecting one or multiple slides and placing each slide or grouping of slides in a particular location in the grid view interface 500 (e.g., row and/or column locations). The sequence 510 of the presentation can read from left to right, while the chapters or sections 505 may read from top to bottom of the grid view interface 500. Other sequence 510 and section/chapter 505 arrangements are also contemplated (e.g., based on cultural norms of a particular geographic area).

As described herein, the presentation may be created and edited by multiple remote collaborators of diverse design skills and experience. The grid view interface 500 facilitates an organizer of the collaboration group to assign sections or chapters 505 of the presentation to individuals or teams of the collaboration group. For example, the organizer can determine that a chapter of the presentation corresponding to the third row of the grid view interface 500 will involve custom designs or complex features that require the skills of a professional design team. Accordingly, the organizer can assign the chapter 505 corresponding to row three to a professional design team of the collaboration group.

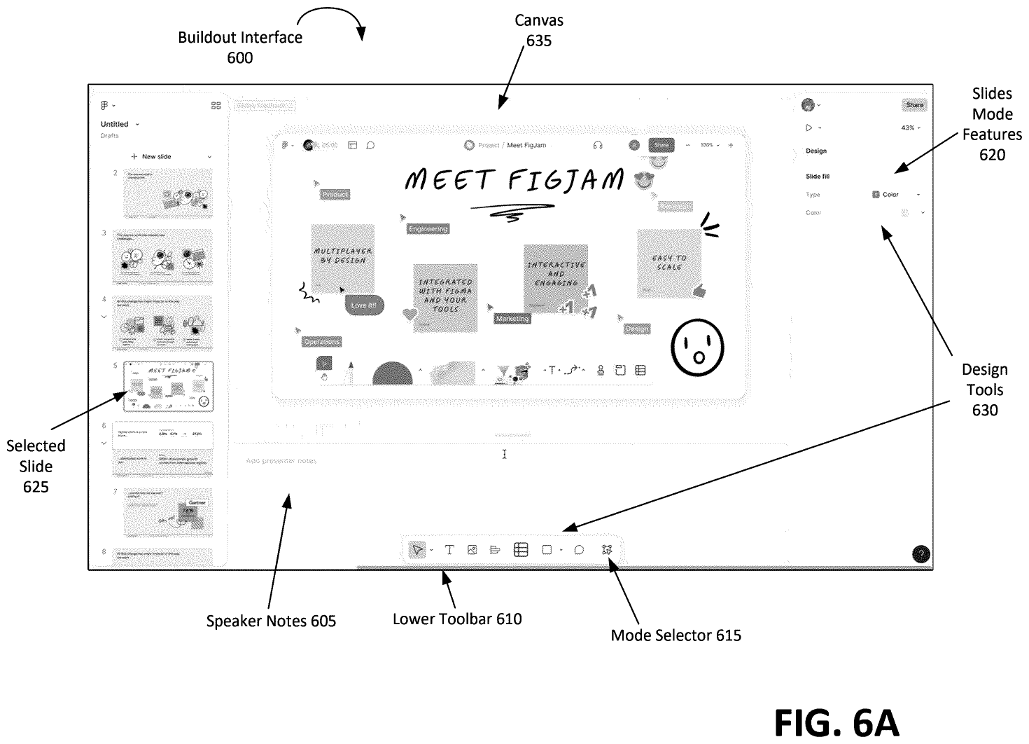

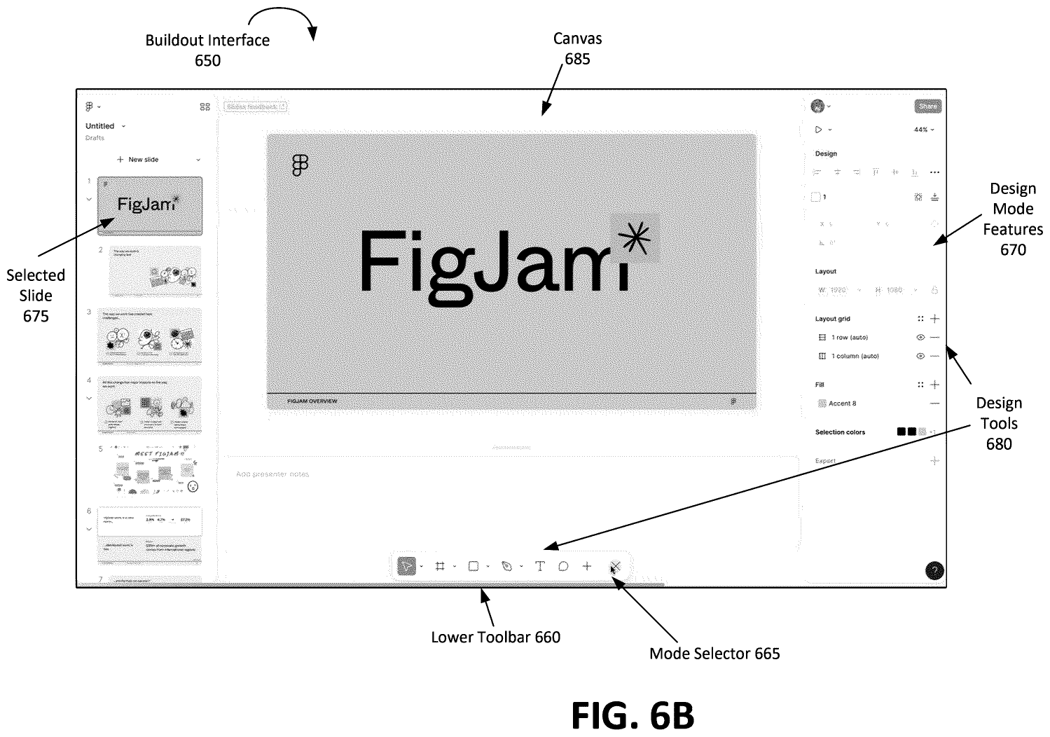

FIG. 6A illustrates a presenter notes feature and modality selector for the slide deck buildout interface 600, according to examples described herein. As shown in FIG. 6A, the buildout interface 600 can further include a speaker notes textbox feature 605 that enables the user to include notes for a select slide 625, which would be shown to the speaker but not the audience (discussed further below). As further shown in FIG. 6A, the buildout interface 600 can include the slide deck column shown in previous examples, and a selected slide 625 that is presented on the canvas 635.

When the selected slide 625 is presented on the canvas 635, the user can utilize a set of design tools 630 and lower toolbar 610 to make changes to the selected slide 625. In various examples, the lower toolbar 610 can include a mode selector 615 that switches between a slides mode and a design mode (described below). In the slides mode, a set of slides mode features 620 are included in the set of design tools 630 that enable the user to edit and create on the selected slide 625. As provided herein, the slides mode provides more intuitive design tools 630 for non-designers or beginner designers, such as design tools for adding text, shapes, colors, notes, images, preconfigured animations, and the like. The set of design tools 630 for the slides mode can be accessed by the user in the slides mode features 620 and/or the lower toolbar 610.

FIG. 6B illustrates a modality change in the buildout interface 650 to a design mode, according to examples provided herein. As shown in FIG. 6B, a selected slide 675 is presented on the canvas 685, and the user has selected the mode selector 665 to initiate the design mode, which provides a more complex set of design tools 680 and design mode features 670 that are configured for more adept or professional designers. Upon selecting the mode selector 665, the lower toolbar 660 changes to include additional design tools, such as design tools for creating more fine-grained and/or customized edits on the selected slide 675. For example, the set of design tools 680 in the design mode can include features for fine-tuning the layout of the slide and features of the slide, configuring accents, drawing by hand, and other fine-grained design features.

In various examples, the additional design tools in the design mode can include a whiteboarding set of tools for use with a whiteboard application. By way of example, the set of design tools can enable the user to select objects by shape, type (e.g., geometric object, text-based object (e.g., stickie note), and by function (e.g., stamps or widgets, etc.). Further, the set of design tools can enable the user to configure attributes for selected objects, where the attributes include, for example, color fill, size, line attributes and text properties. The set of design tools can also be implemented for use with a graphic design application. For example, the set of design tools can enable users to select frames or slides, frame or slide attributes, relationships between frames or slides, and other attributes. The design tools can enable users to apply attributes to select frames or slides, such as, for example, a fill attribute (e.g., pattern, color, etc.), line attributes (e.g., line weight, color, pattern, end detail) and text attribute. Still further, the design tools can enable users to specify one or more types of logical relationships between frames or slides, including spacing or logical relationship.

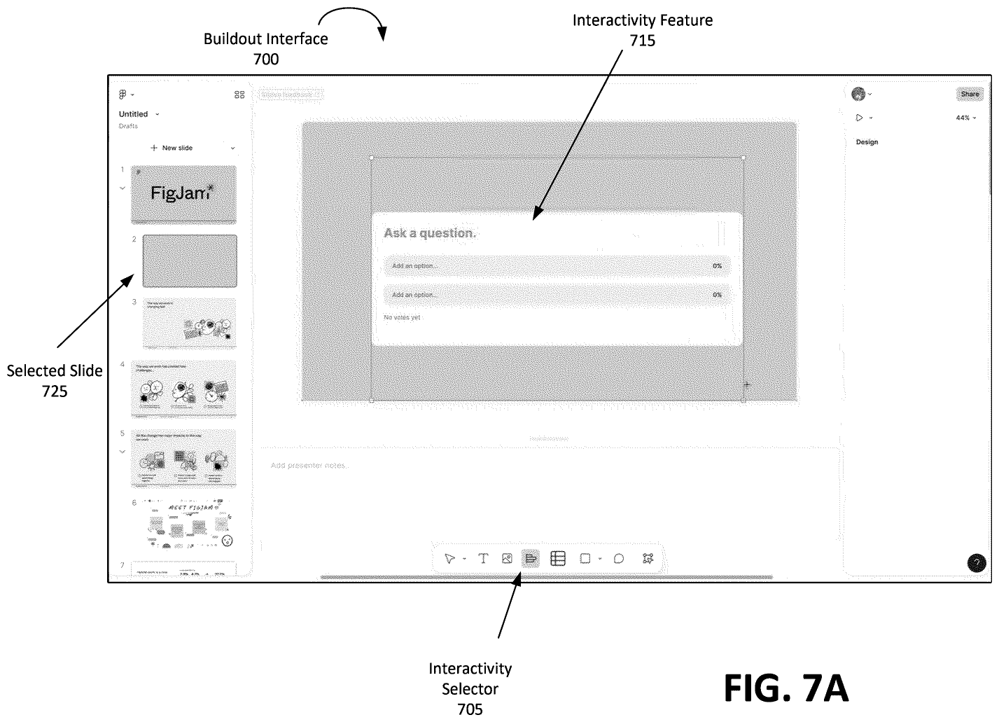

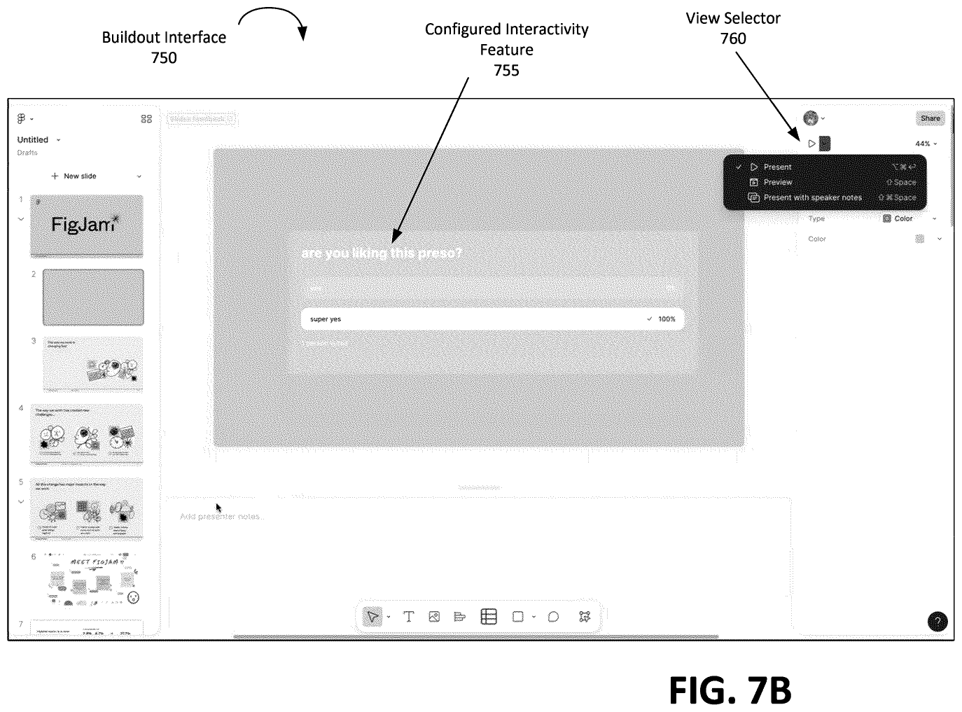

FIG. 7A illustrates a presentation interactivity tool for creating two-way interactivity in a presentation, according to examples described herein. In the buildout interface 700, the user can select an audience interactivity selector 705 in the lower toolbar, which can cause an interactivity feature 715 to be presented on a selected slide 725. The user may then configure the interactivity feature 715 to create audience engagement for the resultant presentation. For example, the interactivity feature 715 can be configured by the user to ask the audience a question, conduct a poll with the audience, request feedback from the audience, and the like. In such examples, the audience may engage with individual computing devices to receive the configured interactivity feature 715, or may be viewing the presentation remotely on a computing device (e.g., a desktop computer).

FIG. 7B illustrates configuration of the presentation interactivity feature 755, according to certain examples described herein. As shown in FIG. 7B, the user can create a configured interactivity feature 755 on the selected slide, which comprises a binary poll asking the audience whether they like the presentation. The binary poll can include two answers each selectable by each audience member viewing the presentation. In certain examples, the user can interact with a view selector 760 that enables the user to view the configured interactivity feature 755 in operation (e.g., in the buildout interface 750, a preview for the presentation, or in a presentation mode with speaker notes).

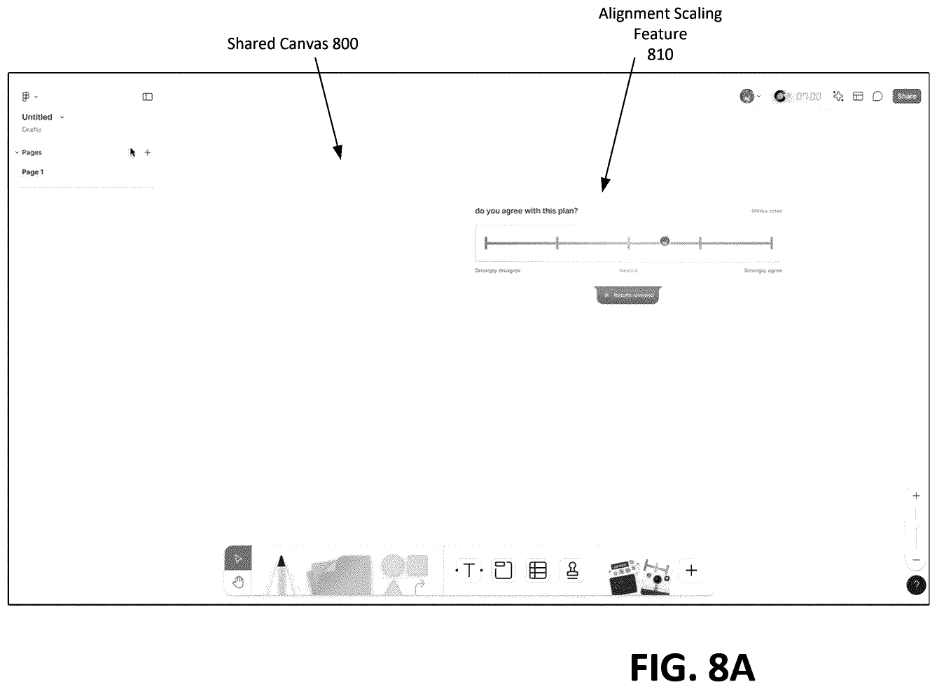

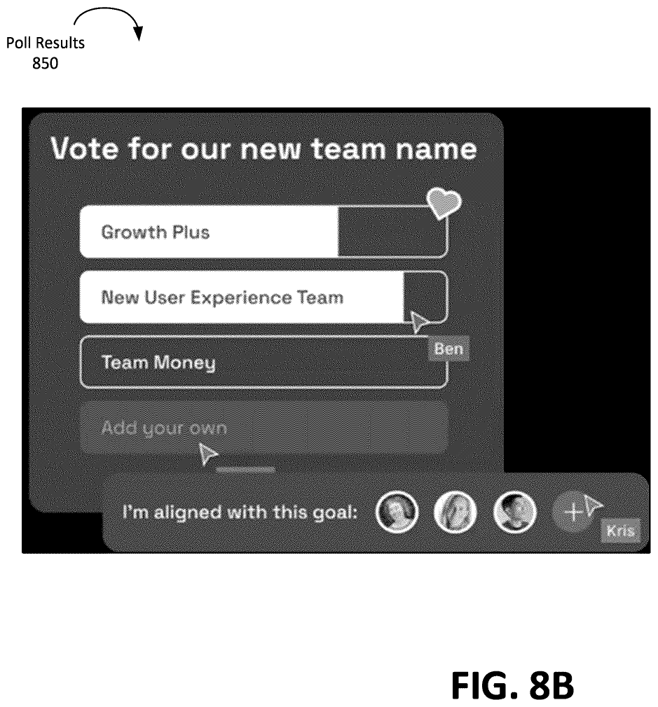

FIG. 8A illustrates an alignment scaling feature for receiving feedback in a workspace file from other collaborators, according to examples described herein. As shown in FIG. 8A, the user can configure an alignment scaling feature 810 for any aspect of the presentation, which may then be presented on the shared canvas 800 presented on the computing devices of the other collaborators. For examples, the alignment scaling feature 810 can be configured to receive input from the other collaborators regarding the strategic plan of the presentation, a title for the presentation, the theme of the design for the presentation, the color of a particular slide, font selection, font size, any content created by the user, a layout or structure of the slides, or any other conceivable aspect of the presentation. The other collaborators may then interact with the alignment scaling feature 810 to provide the requested feedback to the user. The browser application may then accumulate the input from the other collaborators and present the results on the shared canvas 800 of the user and/or all the other collaborators.

FIG. 8B illustrates poll results 850 from a collaboration team where feedback has been requested, according to various examples. In the example shown in FIG. 8B, the poll results 850 correspond to a team name for a particular collaboration team, and the user has been provided with feedback from several members of the collaboration team. In certain scenarios, poll results 850 can comprise results from the alignment scaling feature 810 shown in FIG. 8A. In variations, the poll results 850 can comprise results from an interactivity feature provided to the collaborators, similar to the configured interactivity feature 755 provided to audience members, as shown in FIG. 7B. In certain examples, the poll results 850 can be presented to the user and/or collaborators, and can include a face pile or grouping indicating who voted and/or which person voted for which option.

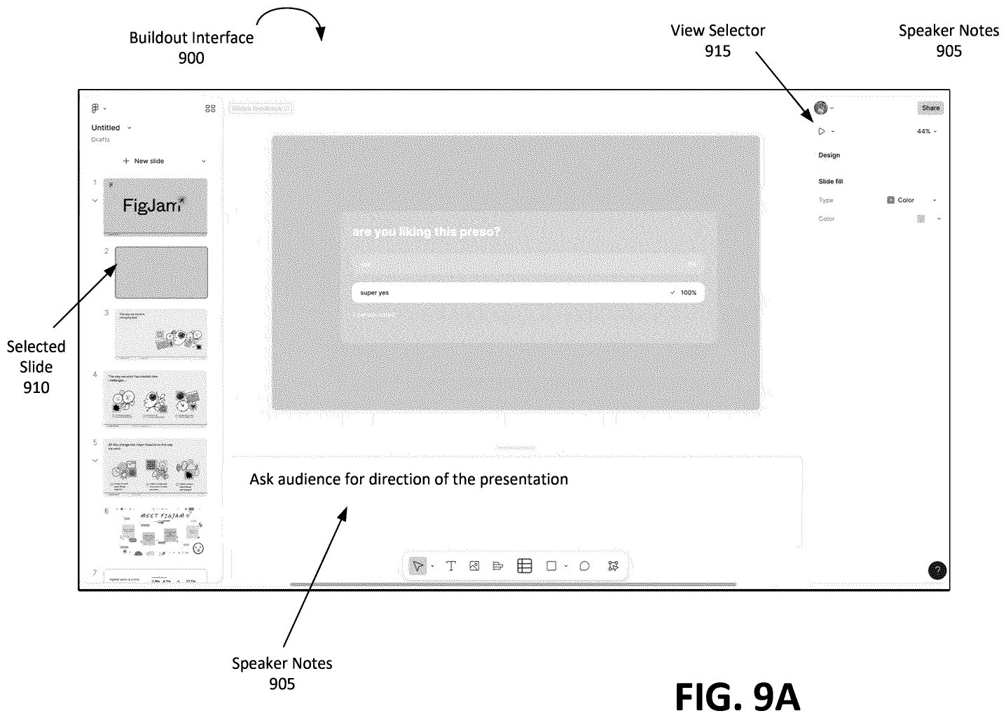

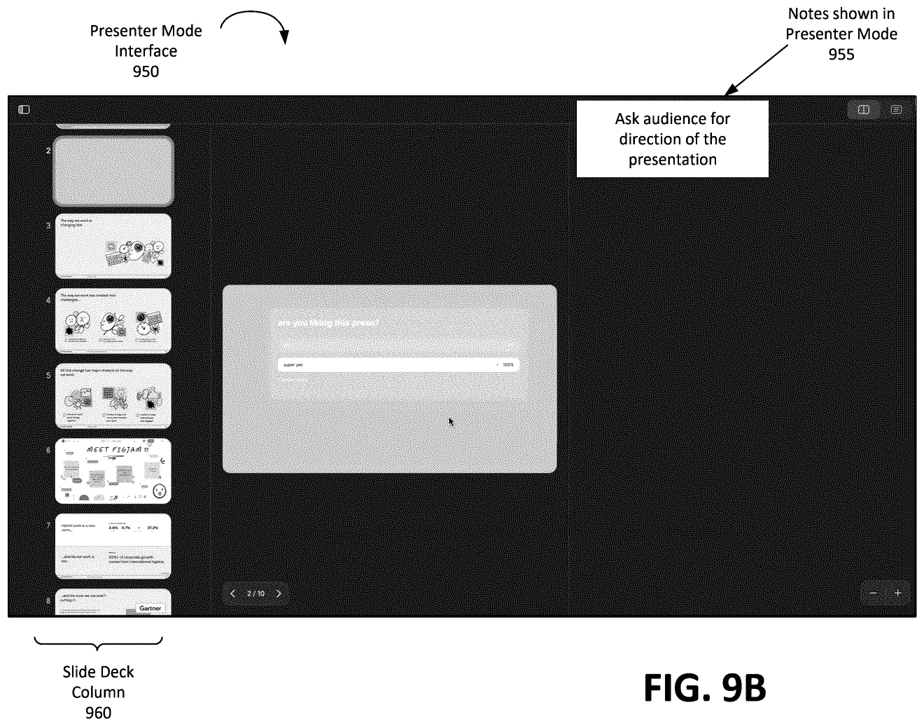

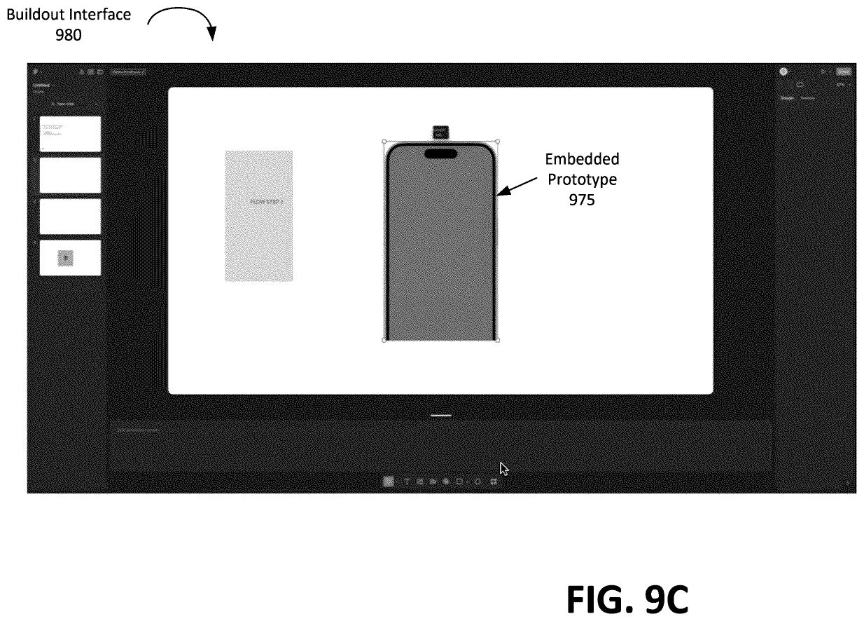

FIG. 9A illustrates a design editor providing slide notes for a presentation, according to certain examples. As shown in FIG. 9A, the buildout interface can include a speaker notes text box 905 as shown in previous examples. The user has typed notes in the speaker notes text box 905 for a selected slide 910. In various examples, the user may then select the view selector 915 to view the selected slide 910 from the audience perspective or the presenter's perspective.

FIG. 9B illustrates a presenter view for a presenter of a content file, according to examples provided herein. In the example shown, the user has selected the presenter view from interacting with the view selector 915 of FIG. 9A, which causes a presenter mode interface 950 to be displayed. In the presenter mode, the user can select from any slide in the slide deck column 960 to view how the slide will be presented to the presenter of the slide deck. As shown in FIG. 9B, the notes 955 for the selected slide 910 in FIG. 9A are displayed in a dedicated area for the presenter, but are not shown to the audience.

The presentation application service can invoke, or otherwise integrate the graphic design application service (or functionality thereof), in order to provide graphic design functionality in context of the operations performed in the presentation of slides. As described, for example, the presentation application service can link to a graphic design application service, or otherwise integrate corresponding function, where a graphic design is available for rendering in one or multiple views, including an interactive view generated through a prototyping or simulation mode of the graphic design application service. With reference to FIG. 9C, for example, an embedded prototype 975 enabling audience interaction with a user interface design, according to examples described herein. In certain implementations, the embedded prototype 975 can be included in a slide deck in which audience members may interact with a simulated user interface (e.g., for an application). For example, the user can create a slide deck for a presentation of a user interface design for an application, where a slide in the presentation includes an embedded prototype 975 of a computing device.

In examples, the embedded prototype 975 can be associated with a collection of cards utilized by an integrated graphic design application, where each card defines a state of a user interface design. For example, the slide deck can be generated by a presentation application service that is integrated with a graphic design application service. The graphic design application can include functionality for implementing a prototype or simulation mode, where an initial card of the collection is rendered in context of a production environment (e.g., displayed on a user device). In the simulation mode, the user can interact with design elements that are intended to receive end user input in the production environment. The users of the presentation application service can utilize tools of the graphic design application while implementing the presentation application service, to generate and collaborate on content for a slide deck, including the creation of cards that collectively form a graphic user interface. As an addition or variation, the presentation application service can access (e.g., import, open a shared workspace file, etc.) that includes the collection of cards.

In examples, the embedded prototype 975 can combine a collection of cards that collectively form a user interface design, with logic that invokes a simulation mode of the graphic design application service. In variations, the logic for implementing the simulation mode can be integrated with the presentation application service. As described, the simulation mode renders individual cards of the collection in a manner that simulates a production environment for the user interface design. In the simulation mode, each design element that is intended to be interactive in the production environment is made interactive, and user interaction with such elements causes state transitions, resulting in, for example, a production rendering of another card that is intended to be responsive to the particular user interaction.

In examples, a designer (or group of designers collaborating on the user interface design) can use the graphic design application service to design the collection of cards that comprise the user interface design. Alternatively, the functionality can be implemented directly through the presentation application service. In designing the collection of cards, the user can define possible sequences or state transitions, responsive to events such as a user interaction with a particular element of the card. Based on designer input, the user interface design can define a state transition, including the next card that is rendered, following a user interaction with an interactive design element. The user interface design can define the state transition (including the next card of the transition) based on the type of interaction (e.g., click, hover, etc.), as well as the particular design element that receives the interaction.

In examples, the embedded prototype 975 can be presented in an initial state (e.g., represented by one of the cards in the collection). Further, the embedded prototype can be associated with functionality that invokes the simulation mode. For example, the embedded prototype can invoke the simulation mode of a graphic design application service, such that the initial card provided with the embedded prototype 975 renders one or more design elements that are interactive in the production environment. Additionally, the initial card can be displayed in context of a production environment (e.g., on a mobile device of an end user). One or more audience members can interact with the production-environment interactive elements to cause the initial card of the user interface design to transition states (e.g., render a next card, based on the type of interaction and the selected design element).

In an example, during the presentation for the user interface design, the slide that includes the embedded prototype 975 can enable audience members to interact with the actual user interface in a simulation mode (e.g., without launching the application). For example, the application may be in development and not yet ready for consumer use. To create the slide, the user can interact with the buildout interface 980 and select an embedded prototype feature from the design tools (e.g., the lower toolbar), which can cause a simulated computing device (the embedded prototype 975) to be presented on the slide. The embedded prototype 975 can present a simulated version of the user interface intended for the application under development. During the presentation, when the slide is presented, the presenter or an audience member can view the user interface (e.g., a home screen of the application), and interact with a simulated version of the user interface as if the application were running on their computing device. In some examples, a “follow” or “spotlight” feature can be included in which audience members may follow a user interacting with the embedded prototype 975, or a particular audience member or the presenter may be spotlighted such that their interactions with the simulated user interface on the embedded prototype 975 is viewable by anyone following or by the entire audience during the presentation.

In additional examples, the presentation application service can also invoke or otherwise integrate a developer mode of the graphic design application service. In the developer's mode, functionality for creating, viewing, and/or editing programmatic code (e.g., executable code) for implementing a corresponding graphic design in a production environment is provided. In some examples, a developer's panel or window can be provided adjacent to the slide deck and/or rendering of the graphic design, in order to enable a developer (or other user) to view programmatic code relating to the specific aspects or feature of a graphic design interface being depicted by a slide (or combination of slides). In this way, the developer's mode generates a view of programmatic code sequence or listing for implementing the specific aspect or feature of the graphic design, adjacent to the portion of the graphic design (as depicted on a slide or combination of slides) containing the specific aspects or feature. In variations, the presentation application service can include a functional feature that enables the user to interact with an aspect of a rendered slide, where the rendered slide displays a graphic design (or portion thereof) that is generated through a graphic design application service, or corresponding integrated functionality. In examples, the type of interaction provided through the functional feature includes generating a side panel or overlay that displays a set of programmatic code for implementing a feature or aspect of a graphic design that is being rendered on a slide. The window or panel can render a corresponding portion of the programmatic code that is used, being developed to use in connection with rendering a corresponding graphic design interface in a production environment. When a slide is rendered in a collaborative session, for example, a user can interact with the slide to view programmatic code for implementing a portion of a graphic design interface. Further, in some examples, the user can navigate the set of programmatic code displayed through the panel or window, and in doing so, the trigger the graphic design application service or functionality to modify the rendering of the graphic design on the corresponding slide, such that the portion of the modified rendering reflects the set of programmatic code that is presently displayed through the panel or window.

Still further, in some examples, a user can edit the set of programmatic code displayed through the panel or window, to cause a corresponding change in the portion of the graphic design that is displayed on the presentation slide. For example, the user can change, in the depicted program code, an attribute for a particular aspect of the graphic design interface, causing the rendering of the corresponding portion of the graphic design file to be changed as well.

Likewise, in other examples, a user can interact with a portion of a graphic design interface that is depicted by a slide, in order to view and modify an attribute or portion of the depicted interface. Such modification can trigger the developer mode functionality (e.g., as involved by the presentation application service) to change the programmatic set of code displayed in the adjacent panel or window. For example, if the user interacts with the slide to alter an attribute of the rendered graphic design as displayed (e.g., by changing a line attribute, fill color, size, inserts an object, etc.), the developer mode can be invoked to update the set of programmatic code that is being rendered in the panel or window. Additionally, the edit to the attribute or portion of the depicted graphic design interface can change the corresponding programmatic code that is displayed in the panel or window.

As another example, an edit from the user can focus on a particular aspect of the rendered graphic design. Alternatively, an edit can cause the rendered portion of the graphic design interface to be swapped for another portion of the graphic design interface, resulting in the panel or window displaying alternate sections of the set of programmatic code for implementing the graphic design interface that is displayed with the presentation slide. The functional feature can be provided by, for example, the presentation application service, as an aspect or feature of a presentation slide. As an alternative or variation, the functional feature can be provided as a tool that can invoke functionality as described. The functional feature can be provided (i) through a developer mode of the design application service, (ii) as a plug-in, or (iii) as an integrated aspect of the presentation application service.

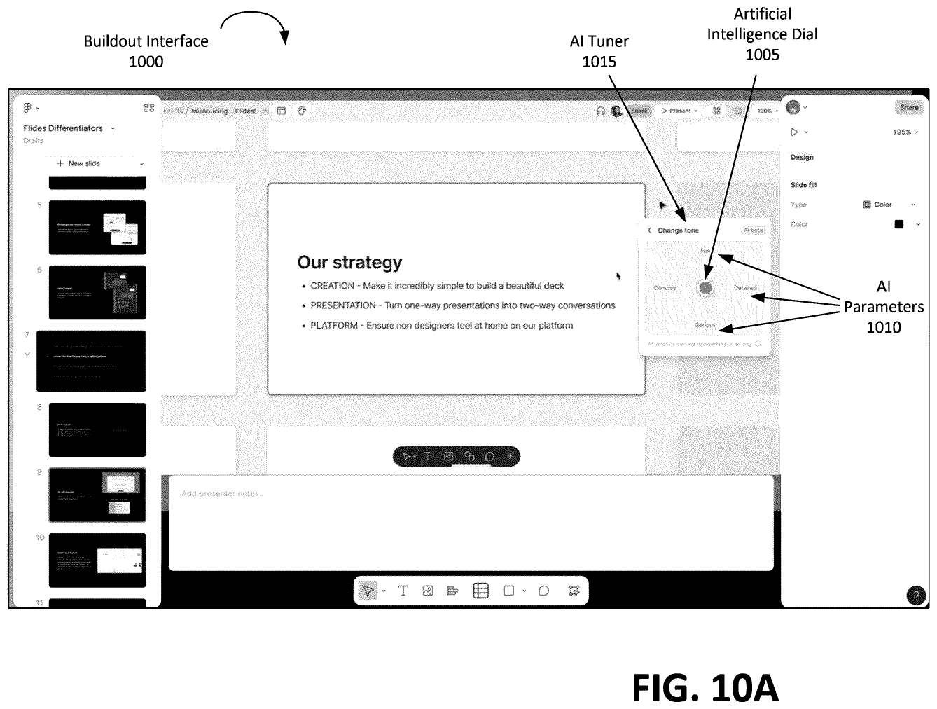

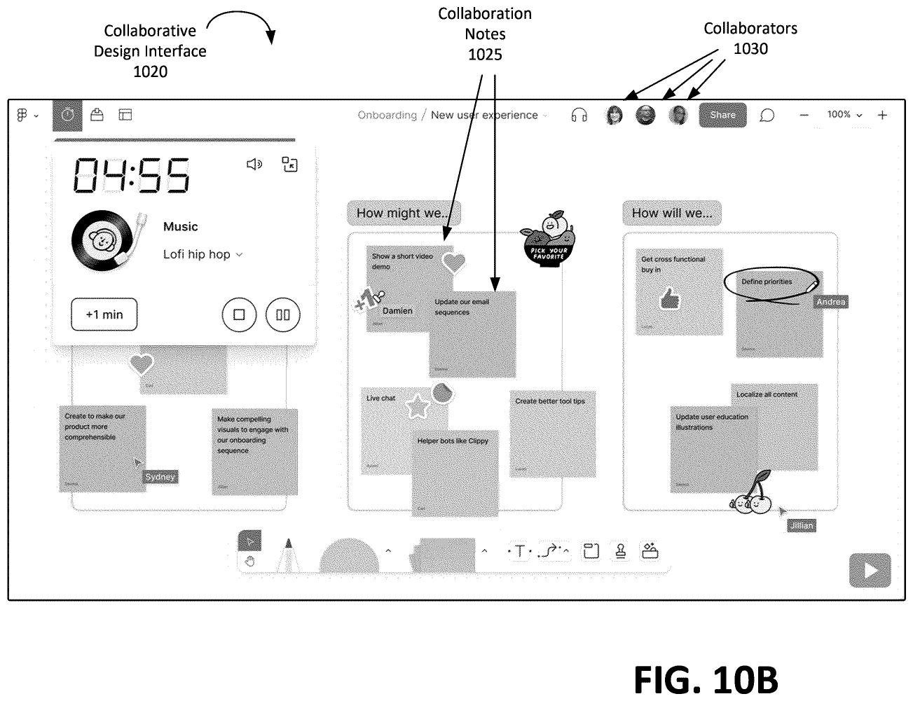

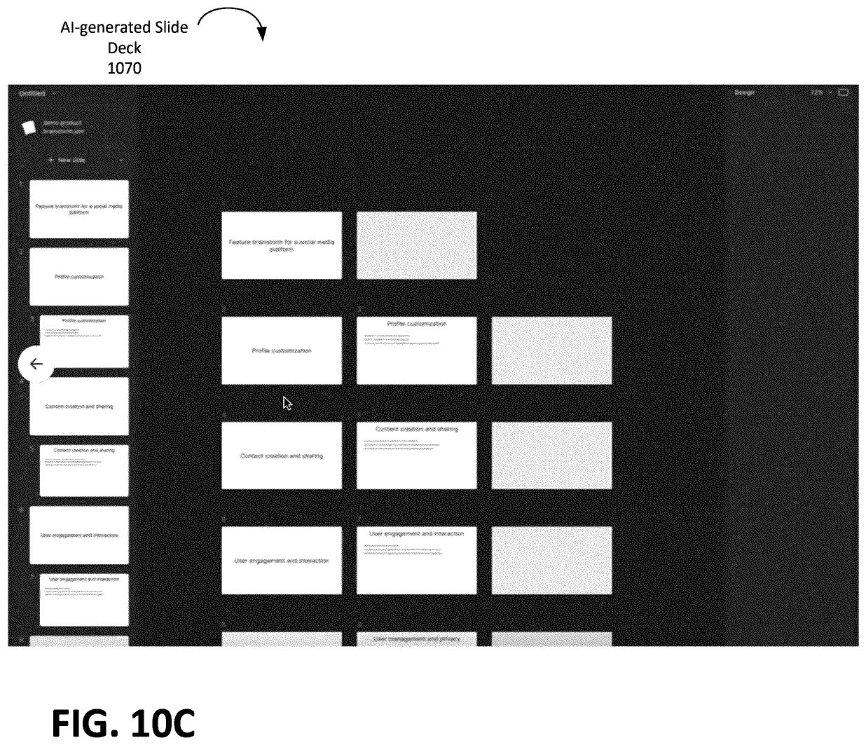

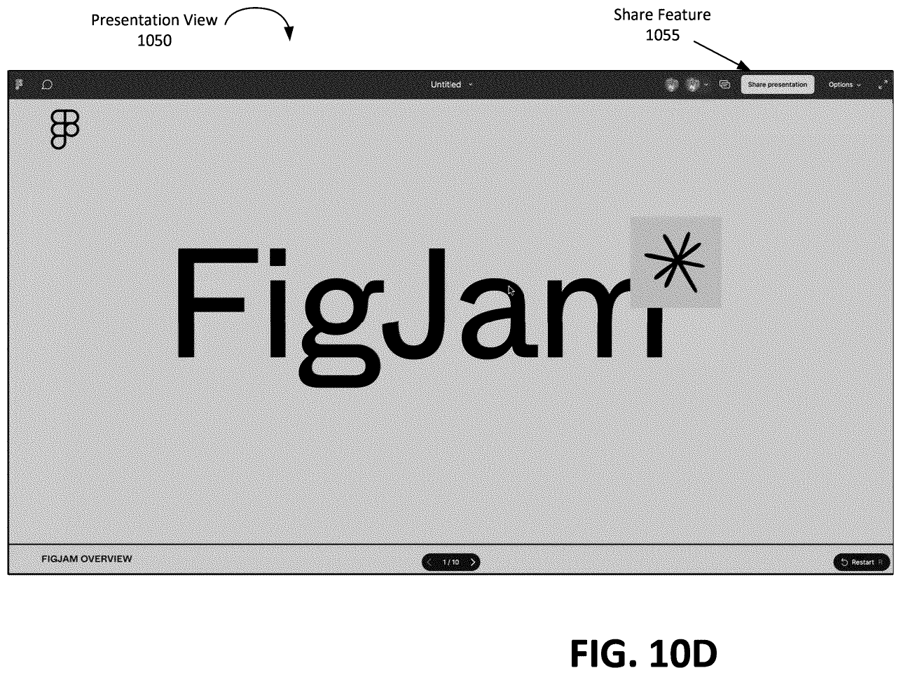

FIG. 10A illustrates an artificial intelligence dial enabling automated styling and/or tone configuration for a content design interface, according to one or more examples. As provided herein, one or more AI design aids can be implemented to automate certain design elements, themes, objects, or text for the presentation. For example, the browser application or network computer system may leverage one or more in-house or third-party AI service providers to perform these automated functions for a user. The user can utilize these AI tools to automatically generate text, themes or color schemes for the presentation, artistic features, slide sequences comprising subjective content, and/or slide or presentation templates to be refined by the collaborators.

In certain examples, the user can configure AI parameters 1010 for an AI dial 1015 to generate automated content. In the example shown in FIG. 10A, the user has used AI tools to generate text for a selected slide. The user can engage with the AI tuner 1015 comprising preconfigured AI parameters 1010 (e.g., including concise, fun, detailed, and serious parameters). The AI tuner 1015 includes two axes, and the user is enabled to move the AI dial 1005 along both axes to tune the parameters 1010 of the AI model(s). The user may then re-execute the AI model(s) to generate content (in this case text) based on the location of the AI dial 1005 in the AI tuner.

While the example shown in FIG. 10A involves automated text, in various examples provided herein, the user can utilize the AI tools to create any type of content for the slide deck, including the slide deck itself, or an initial template for a slide deck. This can include using one or more AI tools to generate a full presentation or a template of a presentation that includes multiple slides, content and/or text for each slide, thematic colors and designs, active or dynamic content for certain slides (e.g., automatically generated GIFs, animations, videos, etc.), and the like. In the example shown in FIG. 10A, the user may utilize one or more AI tools to create an initial slide deck comprising multiple slides for a presentation. The user can review the automatically generated presentation, and in certain examples, can configure the AI parameters 1010 of the AI tuner 1015.

For example, in certain implementations, the user may select from one or more drop down menus or other selection menus of AI parameters on the AI tuner 1015 or other elements of the buildout interface 1000. The listed AI parameters can include various parameters related to design, tone, theme, subject matter, length (e.g., temporal and/or number of slides), and the like. Once the user establishes the AI parameters 1010, the user can move the AI dial 1005 to a desired location of the AI tuner 1015, and cause the one or more AI models to generate automated content accordingly. It is contemplated that this method may be implemented by the user for an entire slide deck or presentation a single slide of the slide deck, or may be implemented by a design team assigned to a subset of the slides.

The AI tuner 1015 can be used to generate initial content for the slide deck or one or more slides of the slide deck, and/or may be used to refine content pertaining to the slide deck. In certain examples, each collaborator during a collaboration session may individually utilize the one or more AI tools, and the automated content generated using the AI tool(s) can be propagated to the workspace files loaded on each computing device of each collaborator. Accordingly, the AI tool(s), including the AI tuner 1015, can enhance collaboration between a particular design team in creating the presentation.

FIG. 10B illustrates a collaborative design interface 1020 in which collaborators have provided input for a content experience, according to examples herein. The collaborative design interface 1020 may be presented on a shared canvas, such as shown and described with respect to FIGS. 1A and 1B, and can facilitate a collaborative design session in which collaborators plan and create a user interface design (e.g., for an application). During one or multiple sessions involving any number of collaborators 1030, collaboration notes 1025 (e.g., “sticky notes” or “stickies”) may be configured and posted by each of the collaborators 1030. As provided herein, as the user interface design is created and developed by user interface designers and collaborators 1030, the design team or collaborators 1030 may wish to create a presentation comprising a slide deck to present the user interface. Described below with respect to FIG. 10C, a user may engage with one or more AI tools to automatically generate a slide deck based on a workspace file corresponding to a user interface design.

FIG. 10C illustrates an AI-generated slide deck 1070 based on a collaborative design, such as a user interface design for an application. As provided herein, the user may select a workspace file corresponding to a collaborative design (e.g., such as shown with respect to FIG. 10B), and select an AI generator tool to cause an AI model to automatically generate a slide deck 1070 based on the collaborative design, including various features from collaboration notes and any other features that are expressible with text. Upon selecting the AI generator feature, an AI model automatically produces a slide presentation. In certain examples, automated summarization of the text representation of the workspace file is performed prior to sending an AI-generator request to the AI model. In further implementations, an automated theme can also be included in the AI-generated slide deck. For example, locations and interactions between objects in the workspace file (e.g., text object, whether a sticky overlaps another sticky, etc.) may be parsed and temporal/contextual relationships are extracted. These parameters may be included into the arrangement and ordering of the AI-generated slide deck, and may also be included to generate the template and/or theme of the AI-generated slide deck 1070.

While examples described with respect to FIG. 10C involve AI-generated slide decks based on a collaborative design, it is contemplated that AI-generated slide deck may be generated based on a document or via an AI prompt.

FIG. 10D illustrates a presentation view 1050 for an audience of a designed presentation, according to certain examples herein. In the example shown in FIG. 10B, the user may interact with a share feature 1055 to share the presentation view 1050 with an audience to present the slide deck, or may select the share feature 1055 to share the presentation with the other collaborators.

Examples provided involve various design tools and modes for creating a slide deck or presentation for a team of remote collaborators. Locally, design changes can be automatically propagated across the entire slide deck, such as text style changes, thematic changes, design changes, added objects or features, and the like. Furthermore, examples described herein distinguish from previous implementations by enabling real-time propagation of changes and edits to each workspace file loaded on each computing device of each collaborator. Thus, certain changes are automatically propagated locally on the slide deck presented on the computing device of the user, and are automatically propagated to the respective slide decks presented on each computing device of each collaborator.

Further, the example provided herein enable interactivity between the collaborators regarding feedback and input, as well as interactivity between the presenter and audience using alignment scaling and interactivity features that are configurable by the user or any collaborator. Still further, example described herein provide for interoperability between the network computer system implementing the collaborative design service and in-house or third-party AI systems providing users with supportive AI tools to automate certain tasks relating to slide deck creation, design, and refinement.

### Methodology

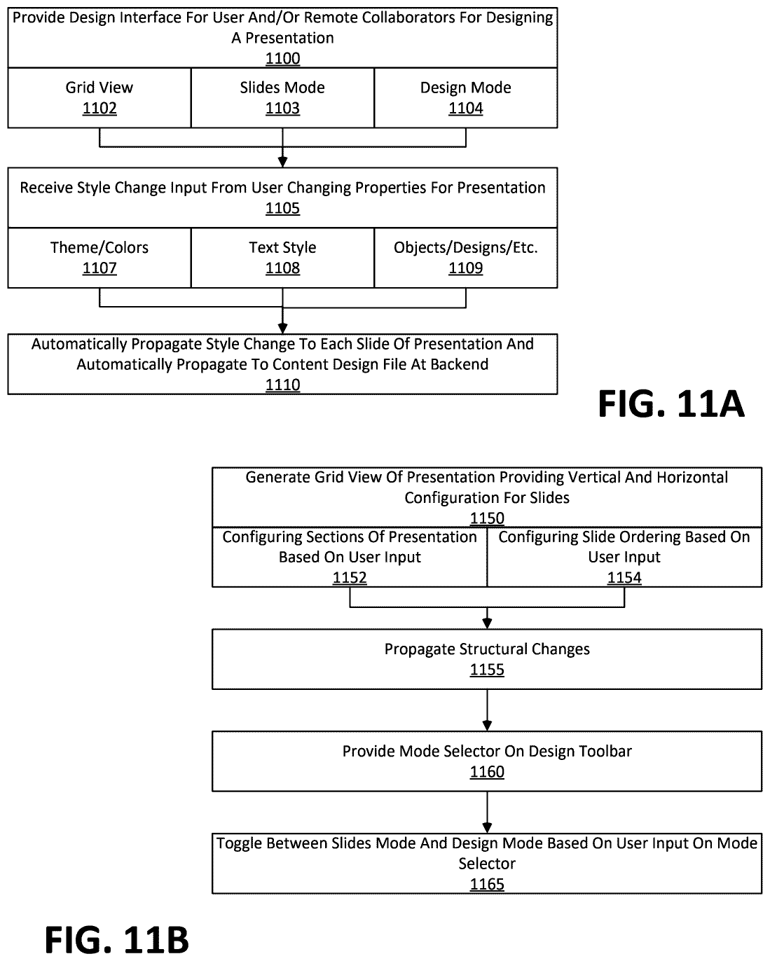

FIGS. 11A, 11B, 12, and 13 are flow charts describing example methods of relating to the embodiments described herein. In the below discussion of the foregoing figures, reference may be made to one or more reference characters representing one or more features shown and described with respect to the other figures shown. Furthermore, any step or process described in connection with the flow charts may be performed prior to, in conjunction with, or subsequent to any other step or process. Any step or process may be performed by one or more user computing devices, the backend network computer system, one or more third-party computing systems, or any combination of the foregoing devices or systems.

FIG. 11A is a flow chart describing an example method of propagating text style changes across a presentation, according to various examples. Referring to FIG. 11A, a user computing device 100 can load a current workspace file 90 via a browser application 110, and a presentation or slide deck design-under-edit corresponding to the workspace file 90 can be presented on a canvas 145 displayed on a displayed device 140 of the user's computing device 100. In various examples, the design-under-edit can present a buildout or design interface for the slide deck or presentation for the user and/or a set of remote collaborators (e.g., during a collaborative design session) for designing a presentation (1100). As provided herein, the design interface can enable the user or any collaborator to interact with the design-under-edit in a grid view (1102), a slides mode (1103), and/or a design mode (1104). As provided herein, the grid view may be initiated in either the slides mode or the design mode.

As described herein, the grid view enables the user or any collaborator to make global changes to the structure of the slide deck, such as ordering of the slides, creating sections or chapters (e.g., enabling easy assignment of certain sections to individuals or design teams). As shown in the example in FIG. 5, the grid view provides vertical and horizontal axes for arranging slides sequentially (e.g., right-to-left) as well as sectionally (e.g., top-to-bottom). As further described herein, the slides mode provides users with relatively rudimentary design tools created for laypeople or non-designers, which are intended to be intuitive for the average user. The design mode provides users with professional design tools for creating design flows, interactive features, customized objects and designs, customized themes, animated objects and/characters, customized transitions (e.g., between slides), and the like.

In various implementations, the browser application 110 can receive a style input from a user to change the properties (e.g., template properties or slide deck properties) of a particular slide deck during a collaboration session with other collaborators (1105). Such style input can comprise a change in the theme and/or color pattern of the slide deck (1107), a change in the text style of the slide deck (1108) (e.g., changes to font, font size, and/or font color of the title, header, sub-header, body, and/or caption of each slide), and/or changes to any objects, designs, etc. that are to apply to each slide of the slide deck (1109). In further examples, the style input can comprise a theme swapping change in which the theme of the slide deck may be changed using a theme swapping feature, as shown and described with respect to FIGS. 4C and 4D.

Upon receiving the style change input, the browser application 110 can automatically propagate the style change to each slide of the presentation as well as automatically propagating the style change to the workspace file 90 at the backend computer system 155 (1110). In doing so, the browser application 110 and backend computer system 155 act to propagate the style change across every slide of the presentation, as well as propagating the style change to each slide deck presented on each computing device of each collaborator in real-time.

FIG. 11B is a flow chart describing an example method of modality changes on a collaborative design interface, according to certain examples. Referring the FIG. 11B, the browser application 110 can generate a grid view of a presentation comprising multiple slides, which can provide a vertical and horizontal configuration of the slides (1150). As provided herein, in the grid view, the user can provide structural inputs to configure sections of the presentation (1152) (e.g., along a vertical axis). In the grid view, the user may further provide structural inputs to configure a slide ordering for each section (1154). Based on these structural inputs in the grid view, the browser application 110 can automatically rearrange the slide deck (e.g., in terms of sections or chapters and in terms of overall ordering), and update the structural changes of the slide deck to the backend computer system, which then propagates the structural changes to the workspace file loaded on each computing device of each collaborator (1155).

In certain examples, the browser application 110 may present a buildout interface for the slide deck, which can include a toolbar comprising a mode selector that enables the user or any other collaborator to locally switch between a slides mode and a design mode (1160). As provided herein, the slides mode is associated with a first set of intuitive design tools that, when selected or toggled, are presented on the buildout interface and the design mode is associated with a second set of more complex design tools that, when selected or toggled, are presented on the buildout interface.

Accordingly, as the user selects the mode selector 615 shown in FIG. 6A in slides mode, the browser application 110 seamlessly switches the design tools 630 and slides mode features 620 of buildout interface 600 to the design tools 680 and design mode features 670 of buildout interface 650 shown in FIG. 6B. Likewise, when the user selectors the mode selector 665 shown in FIG. 6B in design mode, the browser application 110 seamlessly switches the design tools 680 and design mode features 670 shown FIG. 6B to the design tools 630 and slides mode features 620 shown in FIG. 6A. Thus, the browser application 110 toggles the buildout interface between slides mode and design mode based on user inputs on the mode selector 615, 655 (1165).

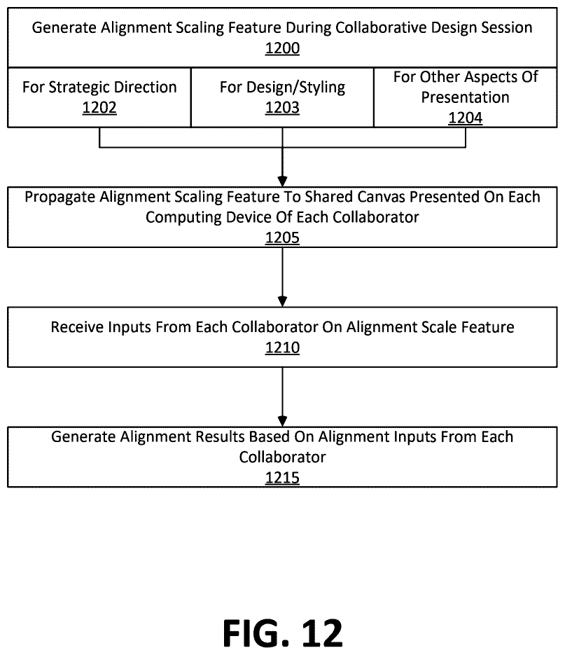

FIG. 12 is a flow chart describing an example method of implementing alignment scaling for a collaborative design session, according to various examples provided herein. Referring to FIG. 12, during a collaboration session with multiple collaborators, the browser application 110 can generate an alignment scaling feature 810 on the design interface presented on the computing device 100 of a user (1200). For example, the user may configure the alignment scaling feature 810 to receive collaborator input or feedback on strategic direction of a slide, a subset of slides, or the overall presentation (1202), to receive collaborator input or feedback on design or styling of one or more slides (1203), or any other aspect of the presentation under edit (1204).

In various examples, the browser application 110 and network computer system 155 can propagate the alignment scaling feature 810 to the shared canvas presented on the computing devices of each collaborator during the collaboration session (1205). For example, the alignment scaling feature 810 may be presented to overlap a current screen displayed on the computing devices of each collaborator, or may be attached to a current slide to which the alignment scaling feature 810 pertains. In one scenario, certain collaborators may not be participating in the current collaboration session, but may be presented with the alignment scaling feature 810 upon loading the workspace file 90 in a subsequent session. As described herein, the alignment scaling feature 810 provides collaborators with the ability to provide alignment input (e.g., strongly disagree, disagree, neutral, agree, strongly agree) along a sliding scale. Accordingly, the network computer system 155 and browser application 110 may receive input from each collaborator on the locally presented alignment scaling feature 810 (1210).

Thereafter, the network computer system 155 and browser application 110 on the computing device 100 of the user can generate and present the alignment results based on the alignment inputs from each collaborator (1215). In certain examples, the alignment results can simply list each collaborator's selection on the alignment scaling feature 810, and/or can combine their selections for presentation on a graph (e.g., providing an averaged result). In further examples, the alignment results can be presented to only the user requesting feedback, or may be presented to all collaborators in the collaborative design session.

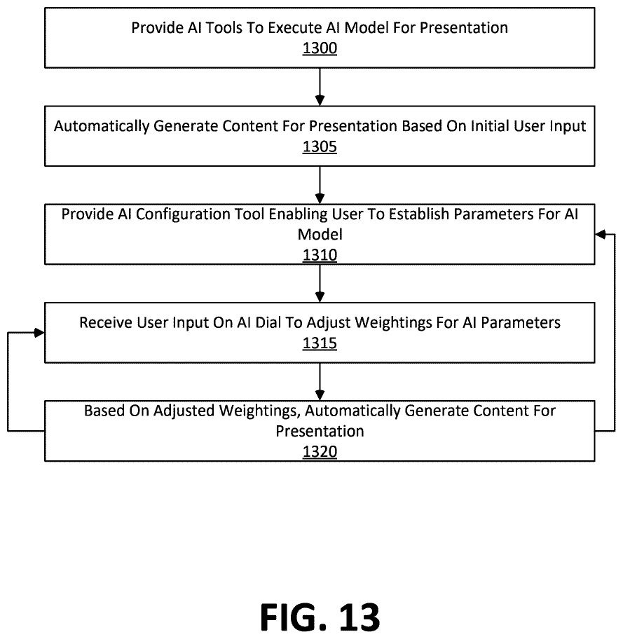

FIG. 13 is a flow chart describing an example method of configuring an artificial intelligence (AI) model to generate automated content for a workspace file, according to various examples, and corresponds to certain features shown and described with respect to FIG. 10A. Referring to FIG. 13, the browser application 110 can cause an AI tool for executing an AI model to be presented on the buildout interface 1000 (1300). As provided herein, the AI tool can include an AI tuner 1015 that includes one or more AI parameters 1010 and an AI dial 1005, as shown in FIG. 10A. Based on an initial user input using the AI tool, the AI tool can automatically generate content for the presentation (1305). As provided herein, the content can comprise stylistic features and objects, text, thematic content, animations, characters, images, videos, GIFs, a particular slide, a group of slides, the entire slide deck, and the like.

In certain examples, the browser application 110 can provide an AI configuration tool that enables the user to establish one or more parameters 1010 for the AI model (1310). The browser application 110 may then receive user input on the AI dial 1005 (moving the dial vertically and/or horizontally) to adjust the weightings for the AI parameters 1010 (1315). Based on the adjusted weightings, the browser application 110 can cause the AI model to automatically generate content for the presentation (1320).

With reference to FIG. 10A, in certain implementations, the user can select one or more AI parameters 1010 from one or more drop down menus or other selection menus of AI parameters on the AI tuner 1015 or other elements of the buildout interface 1000. The listed AI parameters can include various parameters related to design, tone, theme, subject matter, length (e.g., temporal and/or number of slides), and the like. For example, as shown in FIG. 10A, AI parameters 1010 for automatically generating text can comprise “fun” and “concise,” which contrast with “serious” and “detailed.” Once the user establishes the AI parameters 1010, the user can move the AI dial 1005 to a desired location of the AI tuner 1015, and cause the one or more AI models to generate automated content accordingly based on the weighted AI parameters 1010 established by the user.

The AI model may be executed locally, by the network computer system, and/or the weighted parameters and content inputs may be provided to a third-party AI model to automatically generate the desired content. In the latter scenario, the network computer system 50 may include an interface (e.g., an application programming interface) with one or more third-party AI service to provide context and inputs based on the user's configurations with the AI tuner 1015, and received the automated content accordingly.

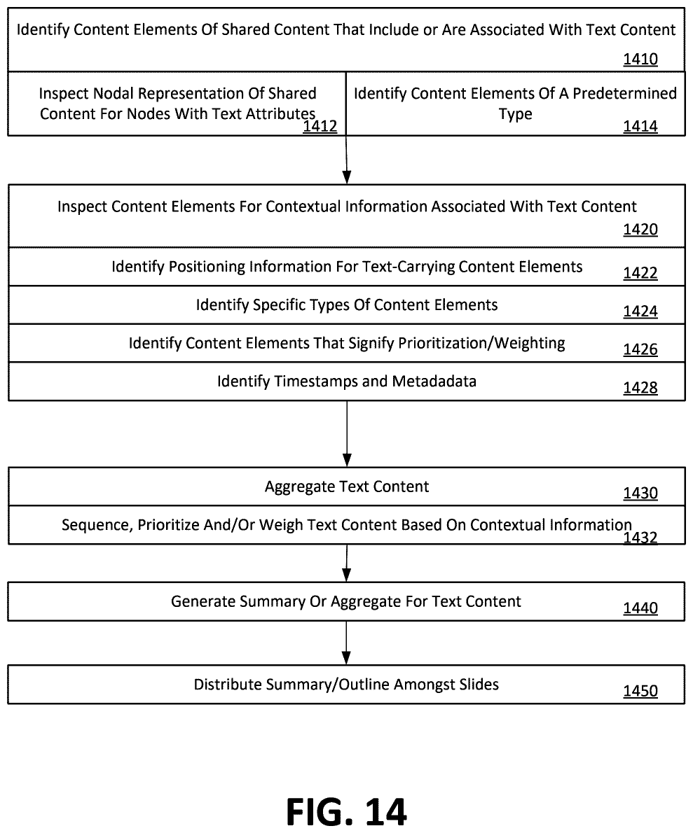

FIG. 14 illustrates a flow chart describing an example method of generating a slide deck from graphic content, according to one or more embodiments.

The browser application 110 can generate shared content 25 in the form of whiteboarding content, which includes graphic and text-based elements. In implementations, the whiteboarding content is graphic-centric, enabling users to, for example, collaboratively create shapes, generate ink content, provide text content, and interact with dynamic content elements. Users can supply text content by selecting a text creation tool and/or selecting content elements that are pre-configured for receiving and displaying text content. For example, the whiteboarding content can include “stickie notes”, corresponding to rectangular boxes that automatically receive text content upon being created on a location of a canvas.

The browser application 110 includes processes that execute on a given user device 11, 12 to identify content elements of the shared content that include or otherwise associated with text content (1410). As described with examples, the whiteboarding content can include a hierarchical nodal representation, with nodal elements representing individual content elements. The nodal representation can define the relationship amongst nodes, as well as the attributes of each node. The browser application 110 inspects the nodal representation to identify nodal elements that are associated with text content (1412). As an addition or variation, the processes of the browser application 110 inspects the whiteboarding content to identify content elements that are of a predetermined type (1414), such as of a type that is designed to receive text content. For example, the browser application 110 can identify “stickie notes” in the whiteboarding content.

In examples, the browser application 110 can also inspect content elements to identify contextual information associated with the identified text content (1420). The contextual information can include data that associates timing (e.g., sequencing, recency, etc.) and prioritization or weight within the text content. For example, in identifying content types of a particular type (e.g., sticky notes), the browser application can identify contextual information that includes positioning of individual content elements (e.g., individual sticky notes) relative to one another (1422). Such an example can detect instances when collaborating users stacked sticky notes on top of one another on a canvas. In such case, the stack of sticky notes can represent a thread of conversation amongst the collaborators. The browser application 110 can identify the position of sticky notes on the canvas to determine that a group of sticky notes are stacked and represented of a thread. The browser application can further use the positioning information to determine the sequencing of the sticky notes, thereby enabling the text content of each sticky note to be sequence relative to the text content of other sticky notes. For example, a second sticky note placed on a first sticky note can signify that the text content of the second sticky note is in response to the text content of the first sticky note. Likewise, a third sticky note placed on the second sticky note signifies that the text content of the third sticky note is responsive to the text content of the first sticky note and/or the second sticky note. By determining the relative position of the sticky notes with respect to one another, the browser application can sequence the text content of the thread.

The contextual information can also identify specific types of content element that relate to a sequencing and/or weight of priority (1424). For example, the browser application 110 can identify connectors between text carrying objects of the canvas. The presence of line connectors, possibly with line ends, indicates the specific text content carried in one object should precede text content provided with another element. For example, if a first rectangular box with text has a line connectors to a second rectangular box with tax, and the two boxes are connected with the line connector, the browser application 110 can infer a sequence between the text content of the first box and the text content of the second box (e.g., the text content of the first box precedes the text content of the second box).

In variations, the browser application 110 can inspect the context to identify predetermined content elements that signify prioritizing or weighting of nearby text-carrying content elements (1426). For example, in the context of a whiteboarding application, the graphic content can include stamps that indicate important or meritorious text content. The browser application can associate sequence, priority or weight to text content based on the presence of predetermined graphic content elements that appear with or near the identified text content.

Still further, the browser application 110 can identify contextual information that includes timestamp information and/or other metadata that may be present with the text-carrying content elements of the canvas (1428).

The browser application 110 can aggregate the identified content (1430). In examples, the browser application 110 can sequence, prioritize or weight the aggregated content based on the contextual information associated with the identified text content (1432).

Next, the browser application 110 programmatically generates an outline or summary of the aggregated text content (1440). In examples, the browser application 110 utilizes one or more large language models (LLM), or an LLM service, to generate the outline or summary.

Further, in examples, the browser application 110 can segment the outline or summary, and then distribute the segments amongst the collection of slides for presentation, and may also automatically place the slides into a template (and/or include a selected or predetermined theme). In certain examples, the user may then edit the slide deck, swap the theme, reject certain aspects of the AI-generated slide deck (e.g., remove slides or change global styles), or change one or more parameters to tune the AI model and re-execute.

### Visual AI Tuning

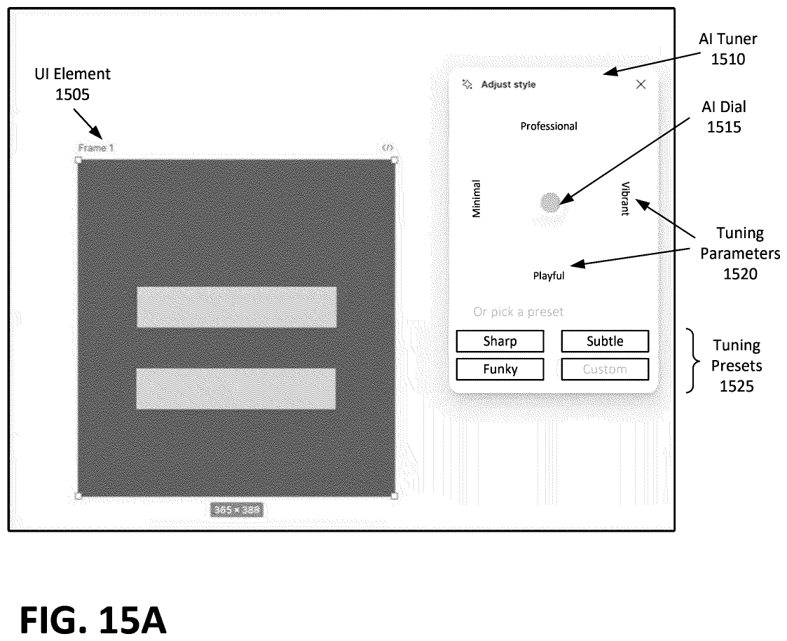

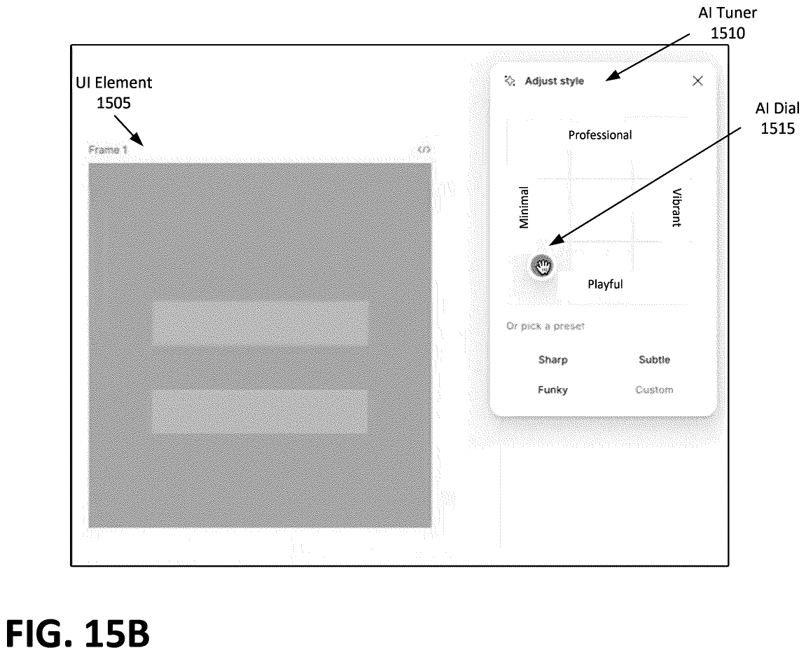

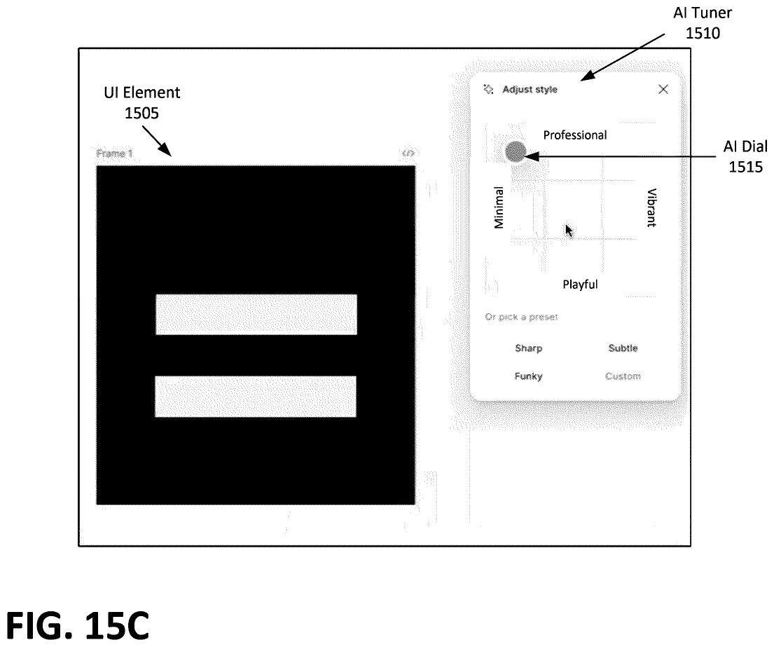

FIGS. 15A through 15C are example interfaces illustrating use of an example AI tuner, according to examples described herein. Referring to FIG. 15A, a simple example is shown in which a UI element 1505 is selected by a user, who selects a design tool to provide an AI tuner 1510. The AI tuner 1510 can include a set of configured or predetermined tuning parameters 1520 that are arranged in a coordinate space. As shown in the AI tuner 1510, the tuning parameters comprise “professional,” “vibrant,” “playful,” and “minimal” parameters each arranged along a respective axis. The AI tuner 1510 further includes an AI dial 1515 that the user can reposition within the coordinate space. Additionally, the AI tuner 1510 can include a number of tuning presets 1525, that the user can select and/or combine with the AI dial 1515 positioning to update the visual aspects of the selected UI element 1505.

In certain implementations, the user can type in or select predetermined tuning parameters and tuning presets 1525 to configure the LLM prompt generator 85 at the backend network computer system 50 (shown in FIG. 1B). As shown in FIG. 15A, the tuning presets 1525 include “sharp,” “subtle,” and “funky” presets, and a text box that enables the user to type in a custom preset. Each of the tuning presets 1515 can be selected to cause the visual aspects of the UI element to be updated based on the description or definition of the selected preset. In further examples, the user may select or key in multiple presets, which can combine to update the selected UI element accordingly. As shown in FIG. 15A, the simple UI element comprises a deep blue and bluish-grey color scheme.

Referring to FIG. 15B, the user has moved the AI dial 1515 to the bottom-left location of the coordinate space, which corresponds to a more minimal and playful visual scheme. In various examples, the user provides input to move the AI dial 1515 to the current location. Once the AI dial 1515 is positioned (e.g., triggered by click-hold-drag-release input), the LLM prompt generator 85 can be triggered to generate an LLM prompt based on the coordinates of the AI dial in the coordinate space of the AI tuner 1510. The LLM 88 then processes the LLM prompt, and returns a dataset that causes the selected element to be visually updated accordingly. As shown in FIG. 15B, the visual appearance of the UI element 1505 has changed to a yellowish-orange and salmon color scheme, which corresponds to the location of the AI dial 1515 within the coordinate space of the AI tuner 1510.

Referring to FIG. 15C, the user has moved the AI dial to an upper-left position of the coordinate space, which corresponds to a more professional and minimal visual design. The selected UI element 1505 is correspondingly updated to a black and white color scheme based on the LLM prompt generator 85 interpreting the AI dial 1515 location, generating an LLM prompt, and communicating with an LLM 88 to obtain a corresponding dataset. As provided herein, the user can manipulate the AI dial 1515 in real time, and the background communications between the LLM prompt generator 85 and LLM 88 can be performed rapidly such that the delay between the AI dial input or preset selection by the user and the implementation of the corresponding dataset from the LLM 88 is minimized.

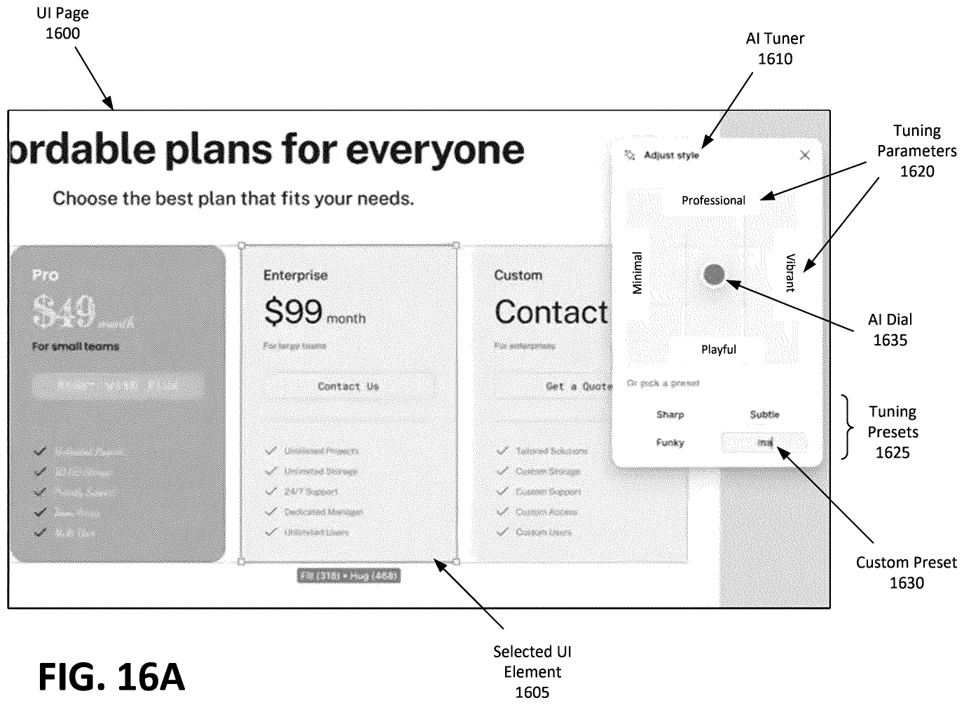

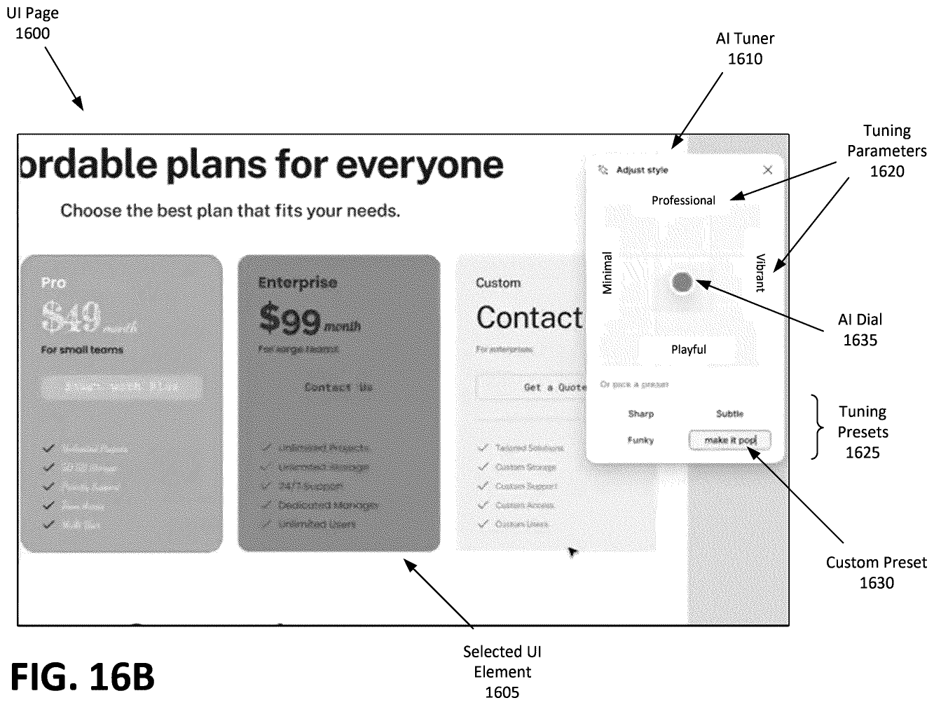

FIGS. 16A and 16B are example interfaces illustrating the use of a custom preset on an example AI tuner on a selected user interface element, according to examples described herein. As shown in FIG. 16A, a user can interact with a UI page 1600, which can be included in a UI design-under-edit that corresponds to a workspace design file. In various examples, the user can select a UI element 1605 and utilize the AI tuner 1610 to update various visual aspects of the selected UI element 1605. As provided herein, the AI tuner 1610 includes a set of tuning parameters 1620 in coordinate space and an AI dial 1635 that the user can manipulate or reposition within the coordinate space to update the visual aspects of the selected UI element 1605.

In various examples, the AI tuner 1610 also includes a set of tuning presets 1625 that the user can select to generate a preset LLM prompt to update the various visual aspects of the selected UI element 1605. In further examples, the tuning presets 1625 can include a custom preset 1630 that enables the user to type in a word or phrase to be interpreted by the LLM 88. Referring to FIG. 16B, the user has typed in the phrase, “make it pop,” into the custom preset 1630 text box, and has left the AI dial 1635, tuning presets 1625, and tuning parameters 1625 of the AI tuner 1610 alone. As shown, certain visual elements of the selected UI element 605 have been updated on the UI page 1600 based on the LLM's interpretation of the phrase typed into the custom preset 1630 text box. Thus, the selected UI element 1605 shown in a relatively plain style in FIG. 16A, has visually updated to include a different color scheme based on the LLM's interpretation of the phrase, “make it pop.”

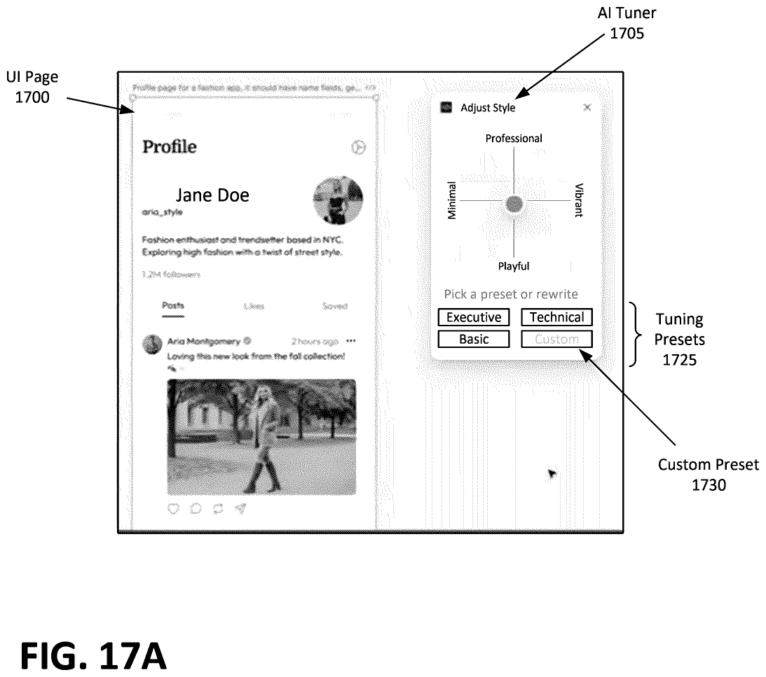

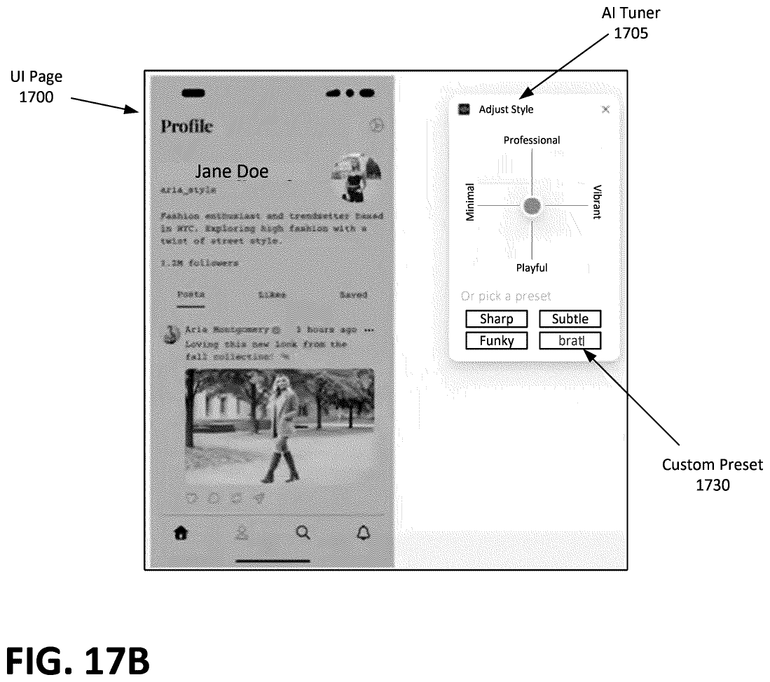

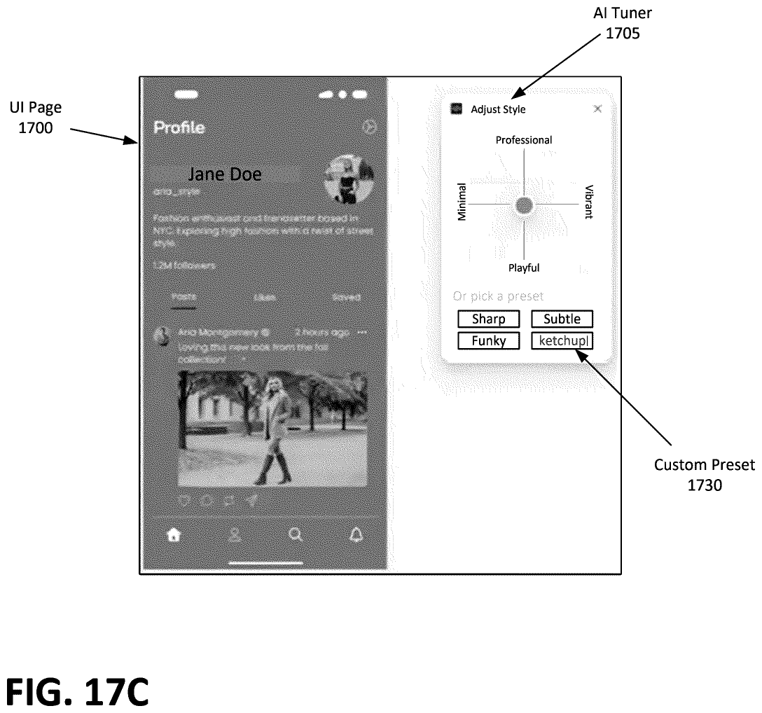

FIGS. 17A through 17C are additional example interfaces illustrating the use of the custom preset on an example AI tuner, according to various examples. Referring to FIG. 17A, a user may make updates to a particular UI page 1700 of a UI design-under-edit. In the example shown, the UI page 1700 comprises a profile page for a fashion app. In various examples, the user can select the AI tuner 1705 to make visual adjustments to the UI page. As shown in FIG. 17A, the AI tuner 1705 includes an AI dial and a set of tuning presets 1725, which includes a custom preset 1730 text box.

Referring to FIG. 17B, the user has typed in the word “brat” into the custom preset 1730 text box of the AI tuner 1705. The LLM prompt generator 85 automatically generates an LLM prompt based on the user typing this word into the custom preset 1730 (e.g., an selecting the “Enter” key). The LLM prompt generator 85 transmits the prompt to the LLM 88, which interprets the word “brat” based on its training, and generates a dataset that, when implemented by the browser application on the user's computing device 12 or the backend network computer system 50, causes the selected UI page 1700 to update its visual characteristics in the manner shown in FIG. 17B.

As another example, referring to FIG. 17C, the user has typed in the word “ketchup” into the custom preset 1730 text box of the AI tuner 1705. The LLM prompt generator 85 automatically generates an LLM prompt based on the user typing this word into the custom preset 1730 (e.g., an selecting the “Enter” key). The LLM prompt generator 85 transmits the prompt to the LLM 88, which interprets the word “ketchup” based on its training, and generates a dataset that, when implemented by the browser application on the user's computing device 12 or the backend network computer system 50, causes the selected UI page 1700 to update its visual characteristics in the manner shown in FIG. 17C.

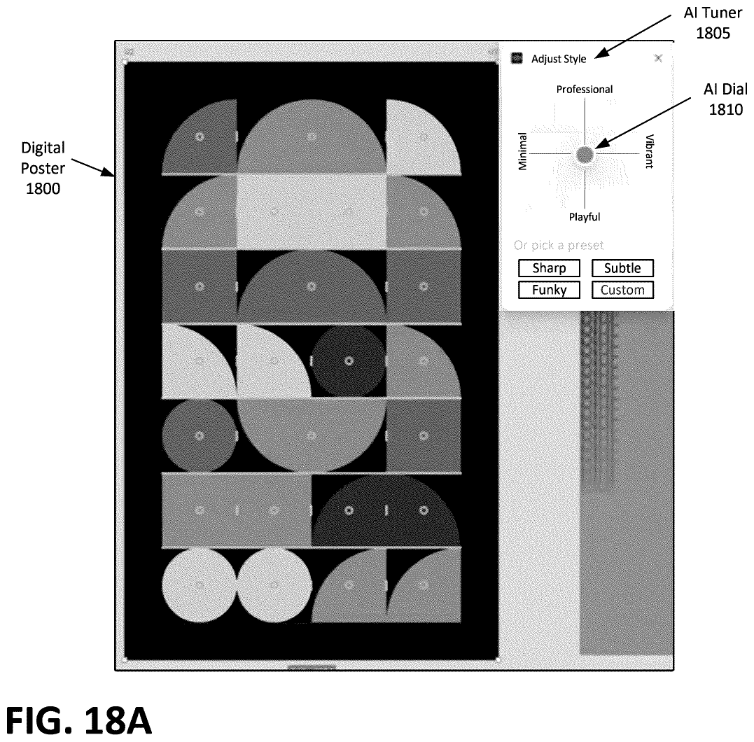

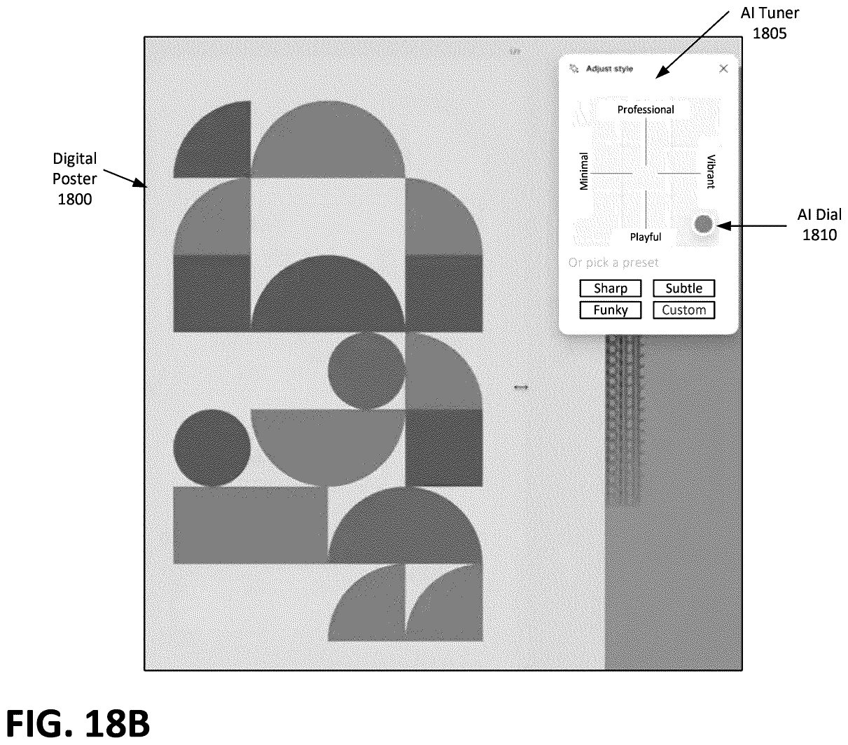

FIGS. 18A and 18B are example digital posters in which a user utilizes an AI tuner 1805, according to various examples. In accordance with examples described herein, the AI tuner 1805 can be implemented with any displayed content, including slide decks, digital posters or images, UI designs, digital paintings and other digital art, video content, websites, and the like. Referring to FIG. 18A, the user can adjust the visual style of the digital poster 1800 using the AI dial 1810 of the AI tuner 1805. Referring to FIG. 18B, the user has moved the AI dial 1810 to the lower-right hand corner of the coordinate space, corresponding to a more playful and vibrant visual design. As shown in FIG. 18B, the digital poster 1800 has been visually updated based on the LLM prompt automatically generated according to the location of the AI dial 1810 in the coordinate space of the AI tuner 1805.

In particular, the LLM prompt can be generated to indicate a degree, percentage, or level of concentration of the particular tuning parameters that correspond to the AI dial's location. In the example shown in FIG. 18B, the LLM prompt may define the coordinate system in accordance with the tuning parameters represented for each axis, and establish a zero value for both “minimal” and “professional” tuning parameters, and level 9 (out of 10) or 90% values for both the “playful” and the “vibrant” tuning parameters. The LLM 88 can interpret these values to generate the dataset that causes the digital poster 1800 to be presented in the manner shown in FIG. 18B.

As provided herein, while examples described herein involve an AI dial in a two-dimensional coordinate system with AI parameters being represented along each axis, other AI tuning methods are also contemplated. For example, one or more tuning dials can be rotatable, with each representing a particular AI parameter, or each AI parameter can be tuned using a slider, similar to those provided on an audio mixer board. In such examples, the user may be enabled to set the AI parameter for each rotatable dial or slider, or can also utilize presets alone or in combination with the AI parameters.

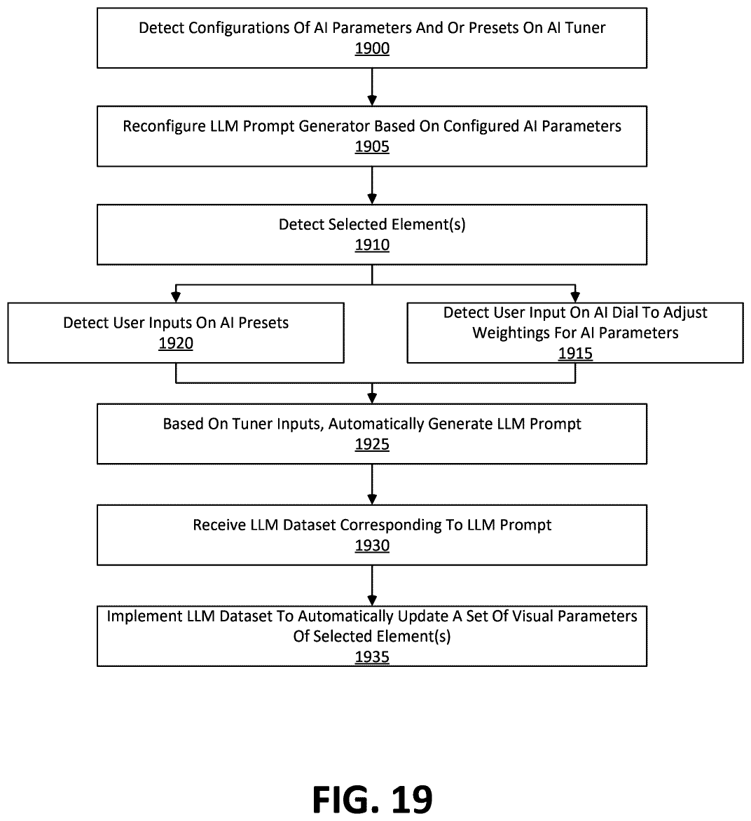

FIG. 19 is a flow chart describing an example method of configuring and implementing an LLM prompt generator 85 dynamically based on user inputs on an AI tuner, according to examples described herein. In various examples, the LLM prompt generator 85 can be included in a backend network computer system 50, 155, such as those described in connection with FIGS. 1A and 1B, which can communicate with a computing system implementing an LLM 88, 158 accordingly. In certain examples, the network computer system 50 can detect configurations of AI parameters and/or presets on an AI tuner (1900). For example, the AI parameters can be configured for each axis on a coordinate system of the AI tuner, or can be configured for alternate embodiments, such as rotatable dials and sliders. In further examples, the user can configure the AI presets on the AI tuner (e.g., by typing in words or selecting from a predetermined menu of words).

In various examples, based on the detected configurations, the network computer system 50 can reconfigure the LLM prompt generator 85 (1905). For example, the LLM prompt generator 85 can interpret inputs by the user on the AI dial (e.g., the user moving the AI dial in the coordinate space) and generate LLM prompts based on the configured parameters representing each axis. At an given time, the network computer system 50 can detect the user selecting one or more elements, such as a UI page, a UI object, frame, or element, a slide or portion of a slide, or other digital content presented on the computing device of the user (1910). The network computer system 50 may then detect user inputs on one or more AI presets (e.g., typing in a custom preset or select a predetermined preset) (1920), and/or detect user input on the AI dial to adjust the weightings for the AI parameters representing each axis (1915).

Based on the inputs provided on the AI tuner, the network computer system 50 can automatically generate an LLM prompt (1925). As provided herein, the LLM prompt can include language instructing the LLM 88 to adjust the visual parameters of the select elements by the user using the configured AI parameters on the AI tuner. The LLM 88 may then interpret the LLM prompt to generate a dataset for visually updating the selected elements. The network computer system 50 may then receive the LLM dataset from the computing system executing the LLM 88, where the LLM dataset corresponds to the LLM prompt (1930). The network computer system 50 may then implement the LLM dataset to automatically update a set of visual parameters of the selected element(s) presented on the computing device of the user (1935). As such, the stylistic design, or other visual aspects of the select element(s) can be automatically changed based on the user's interactions with the AI tuner.

It is contemplated that the AI tuner inputs, interpretation of the tuner inputs, LLM prompt generator 85, communications between the LLM prompt generator 85 and LLM 88, and the implementation of the LLM dataset to update the visual aspect of selected elements can be performed in real time with minimal delay. As such, the user experience in slide deck design, UI design, or the creation of digital designs or digital art is significantly enhanced, with the UI tuner, LLM prompt generator 85, and LLM 88 providing an accelerated visual design tool that improves the functioning of the user's computing device as well as the backend network computer system 50.

### Network Computer System

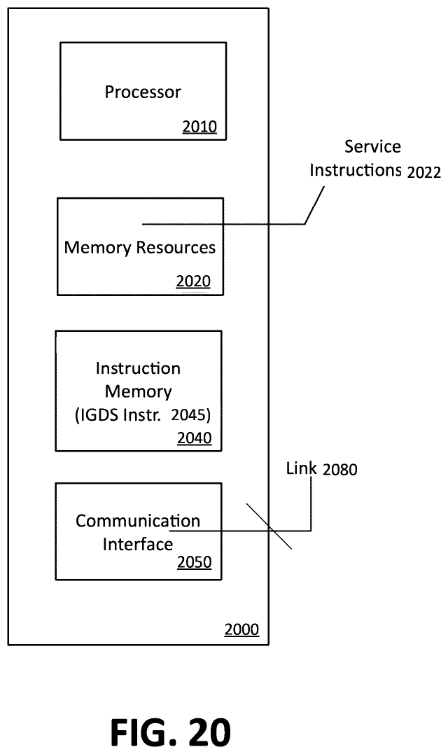

FIG. 20 illustrates a computer system on which one or more embodiments can be implemented. A computer system 2000 can be implemented on, for example, a server or combination of servers. For example, the computer system 2000 may be implemented as the network computer system 155, 50 of FIGS. 1A and 1B.

In one implementation, the computer system 2000 includes processing resources 2010, memory resources 2020 (e.g., read-only memory (ROM) or random-access memory (RAM)), one or more instruction memory resources 2040, and a communication interface 2050. The computer system 2000 includes at least one processor 2010 for processing information stored with the memory resources 2020, such as provided by a random-access memory (RAM) or other dynamic storage device, for storing information and instructions which are executable by the processor 2010. The memory resources 2020 may also be used to store temporary variables or other intermediate information during execution of instructions to be executed by the processor 2010.

The communication interface 2050 enables the computer system 2000 to communicate with one or more user computing devices, over one or more networks (e.g., cellular network) through use of the network link 2080 (wireless or a wire). Using the network link 2080, the computer system 2000 can communicate with one or more computing devices, specialized devices and modules, and/or one or more servers.

In examples, the processor 2010 may execute service instructions 2022, stored with the memory resources 2020, in order to enable the network computing system to implement the collaborative platform and operate as the network computer system 155, 50 in examples such as described with FIG. 1A and FIG. 1B. The computer system 2000 may also include additional memory resources (“instruction memory 2040”) for storing executable instruction sets which are embedded with web pages and other web resources, to enable user computing devices to implement functionality such as described throughout the present disclosure.

As such, examples described herein are related to the use of the computer system 2000 for implementing the techniques described herein. According to an aspect, techniques are performed by the computer system 2000 in response to the processor 2010 executing one or more sequences of one or more instructions contained in the memory 2020. Such instructions may be read into the memory 2020 from another machine-readable medium. Execution of the sequences of instructions contained in the memory 2020 causes the processor 2010 to perform the process steps described herein. In alternative implementations, hard-wired circuitry may be used in place of or in combination with software instructions to implement examples described herein. Thus, the examples described are not limited to any specific combination of hardware circuitry and software.

### User Computing Device

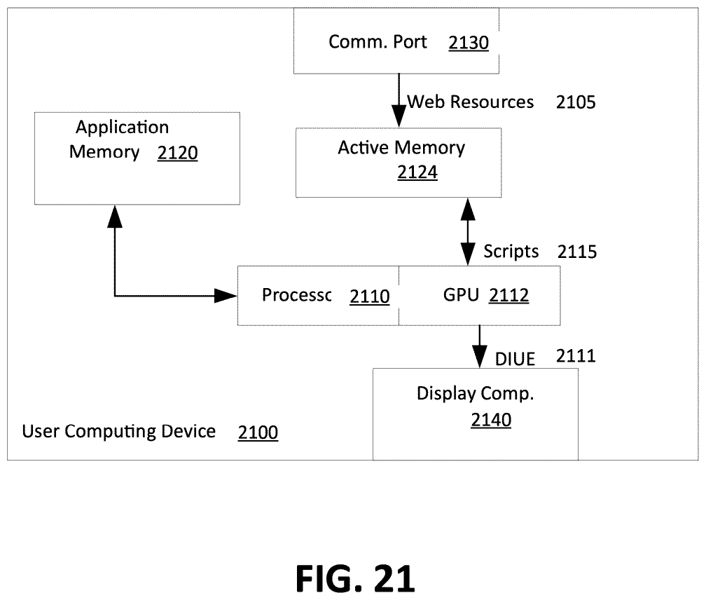

FIG. 21 illustrates a user computing device for use with one or more examples, as described. In examples, a user computing device 2100 can correspond to, for example, the user computing device 100 as shown and described with respect to FIG. 1A, and can comprise a smartphone, tablet computer, AR or VR headset, or other touchscreen-based personal computer having graphics processing capabilities that are suitable for enabling renderings of design interfaces and graphic design work.

In examples, the computing device 2100 includes a central or main processor 2110, a graphics processing unit (GPU) 2112, memory resources 2120, and one or more communication ports 2130. The computing device 2100 can use the main processor 2110 and the memory resources 2120 to store and launch a hybrid web-native collaboration application. In certain examples, a user can operate the application to access a network site of the network collaboration platform, using the communication port 2130, where one or more web pages or other web resources 2105 for the network collaboration platform can be downloaded. In certain examples, the web resources 2105 can be stored in the active memory 2124 (cache).

As described by various examples, the processor 2110 can detect and execute scripts and other logic which are embedded in the web resources 2105 in order to implement the collaborative canvas. In some of the examples, some of the scripts 2115 which are embedded with the web resources 2105 can include GPU accelerated logic that is executed directly by the GPU 2112.

The main processor 2110 and the GPU can combine to render a shared content on a display component 2140 (e.g., touch-sensitive display device). The rendered design interface can include web content from the web aspect of the hybrid application, as well as design interface content and functional elements generated by scripts and other logic embedded with the web resources 2105.

### Example Clauses

CLAUSE 1. A computing device comprising: a display device; a network communication interface; one or more processors; and a memory storing instructions that, when executed by the one or more processors, cause the computing device to: generate a design interface enabling a user to create and design a presentation comprising a slide deck that includes multiple slides; receive a selection of a grid view feature on the design interface; in response to the selection, present the slide deck in a grid view interface that presents the multiple slides of the slide deck in a plurality of rows and columns; receive structural inputs by the user arranging the multiple slides in the plurality of rows and columns; and automatically establish a structure for the slide deck based on the structural inputs, the structure comprising a set of sections for the slide deck based on the plurality of rows and a sequence for each section of the slide deck based on the plurality of columns.

CLAUSE 2. The computing device of clause 1, wherein the design interface is presented on computing devices of a plurality of remote collaborators.

CLAUSE 3. The computing device of clause 1 or 2, wherein the executed instructions further cause the computing device to: transmit data corresponding to the structural inputs to a backend computing system to update a workspace file corresponding to the presentation and automatically propagate the structure of the slide deck to the design interface presented on computing devices of each of the plurality of remote collaborators.

CLAUSE 4. The computing device of any of clauses 1-3, wherein each column of the plurality of columns comprises a section of the presentation, and wherein the user is enabled to assign each column to one or more collaborators of the plurality of remote collaborators for designing the presentation.

CLAUSE 5. A computing device comprising: a display device; a network communication interface; one or more processors; and a memory storing instructions that, when executed by the one or more processors, cause the computing device to: generate a design interface enabling a user to create and design a presentation comprising a slide deck that includes multiple slides, wherein the design interface includes an artificial intelligence (AI) tool for executing an AI model to automatically generate content for the presentation; and based on an initial input corresponding to the user using the AI tool, automatically generate content for the presentation.

CLAUSE 6. The computing device of clause 5, wherein the executed instructions cause the computing device to automatically generate the content for the presentation by transmitting data corresponding to the initial input to a third-party AI service that executes the AI model to automatically generate the content.

CLAUSE 7. The computing device of clause 5 or 6, wherein the AI tool includes an AI tuner that enables the user to adjust one or more parameters for the AI model to automatically generate the content.

CLAUSE 8. The computing device of any of clauses 5-7, wherein the AI tuner further enables the user to establish the one or more parameters.

CLAUSE 9. The computing device of any of clauses 5-7, wherein the AI tuner comprises an AI dial that is movable by the user to a location on the AI tuner that adjusts the one or more parameters.

CLAUSE 10. The computing device of any of clauses 5-7, wherein the automatically generated content comprises one or more stylistic features, objects, text, thematic content, animations, characters, images, videos, GIFs, a particular slide of the slide deck, a group of slides in the slide deck, or the slide deck.

CLAUSE 11. A network computer system comprising: a network communication interface; one or more processors; and a memory storing instructions that, when executed by the one or more processors, cause the computing system to: detect a user selection of an element presented on a display screen of a computing device of a user; detect user inputs by the user on an artificial intelligence tuner presented on the display screen; based on the user inputs on the artificial intelligence tuner, automatically generate a large-language-model (LLM) prompt; transmit the LLM prompt to a computing system implementing an LLM; receive a dataset corresponding to the LLM interpreting the LLM prompt; and implementing the dataset on the selected element to update a set of visual characteristics of the selected element.

CLAUSE 12. The network computer system of clause 11, wherein the selected element comprises a user interface page, a user interface frame, a user interface object, a slide, or a slide element of a slide deck.

CLAUSE 13. The network computer system of clause 11 or 12, wherein the artificial intelligence tuner includes an artificial intelligence dial that is movable in a coordinate system comprising multiple axes, and wherein each axis of the coordinate system corresponds to one or more visual parameters.

CLAUSE 14. The network computer system of any of clauses 11-13, wherein the user moves the artificial intelligence dial within the coordinate system to cause an LLM generator of the network computer system to automatically generate the LLM prompt, and wherein the set of visual characteristics updated based on the dataset correspond to a location of the artificial intelligence dial within the coordinate system.

CLAUSE 15. The network computer system of any of clauses 11-14, wherein the artificial intelligence tuner includes one or more rotatable dials for tuning one or more visual parameters of the selected element.

CLAUSE 16. The network computer system of any of clauses 11-15, wherein the artificial intelligence tuner includes one or more sliders for tuning one or more visual parameters of the selected element.

CLAUSE 17. The network computer system of any of clauses 11-16, wherein the artificial intelligence tuner further includes a set of selectable presets that, when selected cause the LLM prompt generator to automatically generate a preset prompt for updating the set of visual characteristics of the selected element.

CLAUSE 18. The network computer system of any of clauses 11-17, wherein the set of selectable presets includes a customized preset that enables the user to customize a visual parameter.

CLAUSE 19. The network computer system of any of clauses 11-18, wherein the customized preset includes a text box in which the user is enables to type in a word or phrase that is interpretable by the LLM to update the one or more visual characteristics of the selected element.

CLAUSE 20. A computer implemented method comprising steps in any of clauses 1-19.

CLAUSE 21. One or more non-transitory computer-readable media storing instructions that, when executed by one or more processors, cause the one or more processors to perform any of the steps included in clauses 1-19.

### CONCLUSION

Although examples are described in detail herein with reference to the accompanying drawings, it is to be understood that the concepts are not limited to those precise examples. Accordingly, it is intended that the scope of the concepts be defined by the following claims and their equivalents. Furthermore, it is contemplated that a particular feature described either individually or as part of an example can be combined with other individually described features, or parts of other examples, even if the other features and examples make no mentioned of the particular feature. Thus, the absence of describing combinations should not preclude having rights to such combinations.

What is claimed is:

1. A computing device comprising:
a display device;
a network communication interface;
one or more processors; and
a memory storing instructions that, when executed by the one or more processors, cause the computing device to:
generate a design interface enabling a user to create and design a presentation comprising a slide deck that includes multiple slides;
receive a selection of a grid view feature on the design interface;
in response to the selection, present the slide deck in a grid view interface that presents the multiple slides of the slide deck in a plurality of rows and columns;
receive structural inputs by the user arranging the multiple slides in the plurality of rows and columns; and
automatically establish a structure for the slide deck based on the structural inputs, the structure comprising a set of sections for the slide deck based on the plurality of rows and a sequence for each section of the slide deck based on the plurality of columns.

2. The computing device of claim 1, wherein the design interface is presented on computing devices of a plurality of remote collaborators.

3. The computing device of claim 2, wherein the executed instructions further cause the computing device to:
transmit data corresponding to the structural inputs to a backend computing system to update a workspace file corresponding to the presentation and automatically propagate the structure of the slide deck to the design interface presented on computing devices of each of the plurality of remote collaborators.

4. The computing device of claim 2, wherein each column of the plurality of columns comprises a section of the presentation, and wherein the user is enabled to assign each column to one or more collaborators of the plurality of remote collaborators for designing the presentation.

5. A computing device comprising:
a display device;
a network communication interface;
one or more processors; and
a memory storing instructions that, when executed by the one or more processors, cause the computing device to:
generate a design interface enabling a user to create and design a presentation comprising a slide deck that includes multiple slides, wherein the design interface includes an artificial intelligence (AI) tool for executing an AI model to automatically generate content for the presentation; and
based on an initial input corresponding to the user using the AI tool, automatically generate content for the presentation.

6. The computing device of claim 5, wherein the executed instructions cause the computing device to automatically generate the content for the presentation by transmitting data corresponding to the initial input to a third-party AI service that executes the AI model to automatically generate the content.

7. The computing device of claim 5, wherein the AI tool includes an AI tuner that enables the user to adjust one or more parameters for the AI model to automatically generate the content.

8. The computing device of claim 7, wherein the AI tuner further enables the user to establish the one or more parameters.

9. The computing device of claim 7, wherein the AI tuner comprises an AI dial that is movable by the user to a location on the AI tuner that adjusts the one or more parameters.

10. The computing device of claim 5, wherein the automatically generated content comprises one or more stylistic features, objects, text, thematic content, animations, characters, images, videos, GIFs, a particular slide of the slide deck, a group of slides in the slide deck, or the slide deck.

11. A network computer system comprising:
a network communication interface;
one or more processors; and
a memory storing instructions that, when executed by the one or more processors, cause the computing system to:
detect a user selection of an element presented on a display screen of a computing device of a user;
detect user inputs by the user on an artificial intelligence tuner presented on the display screen;
based on the user inputs on the artificial intelligence tuner, automatically generate a large-language-model (LLM) prompt;
transmit the LLM prompt to a computing system implementing an LLM;
receive a dataset corresponding to the LLM interpreting the LLM prompt; and
implementing the dataset on the selected element to update a set of visual characteristics of the selected element.

12. The network computer system of claim 11, wherein the selected element comprises a user interface page, a user interface frame, a user interface object, a slide, or a slide element of a slide deck.

13. The network computer system of claim 11, wherein the artificial intelligence tuner includes an artificial intelligence dial that is movable in a coordinate system comprising multiple axes, and wherein each axis of the coordinate system corresponds to one or more visual parameters.

14. The network computer system of claim 13, wherein the user moves the artificial intelligence dial within the coordinate system to cause an LLM generator of the network computer system to automatically generate the LLM prompt, and wherein the set of visual characteristics updated based on the dataset correspond to a location of the artificial intelligence dial within the coordinate system.

15. The network computer system of claim 11, wherein the artificial intelligence tuner includes one or more rotatable dials for tuning one or more visual parameters of the selected element.

16. The network computer system of claim 11, wherein the artificial intelligence tuner includes one or more sliders for tuning one or more visual parameters of the selected element.

17. The network computer system of claim 16, wherein the artificial intelligence tuner further includes a set of selectable presets that, when selected cause the LLM prompt generator to automatically generate a preset prompt for updating the set of visual characteristics of the selected element.

18. The network computer system of claim 17, wherein the set of selectable presets includes a customized preset that enables the user to customize a visual parameter.

19. The network computer system of claim 18, wherein the customized preset includes a text box in which the user is enables to type in a word or phrase that is interpretable by the LLM to update the one or more visual characteristics of the selected element.
